(19) United States
(12) Patent Application Publication
(10) Pub. No.: US 2014/0314617 A1
(43) Pub. Date: Oct. 23, 2014

(54) DENTAL ALLOY FOR CAD/CAM MACHINING

(71) Applicants: Kyeong Jun Park, Goyang-si (KR); Jeong Jong Park, Goyang-si (KR); Sun Wook Cho, Goyang-si (KR)

(72) Inventors: Kyeong Jun Park, Goyang-si (KR); Jeong Jong Park, Goyang-si (KR); Sun Wook Cho, Goyang-si (KR)

(73) Assignee: CERAGEM BIOSYS CO., LTD., Seoul (KR)

(21) Appl. No.: 14/112,028

(22) PCT Filed: Apr. 13, 2012
(86) PCT No.: PCT/KR2012/002842

§ 371 Date: May 29, 2014

(30) Foreign Application Priority Data
Apr. 15, 2011 (KR) 10-2011-0035022

(51) Int. Cl. C22C 30/02; C22C 28/00; A61C 5/00; C22C 19/03; C22C 19/07; C22C 5/06; C22C 5/04; C22C 30/00

(52) U.S. Cl. CPC C22C 30/02; C22C 5/04; C22C 28/00; C22C 30/00; C22C 19/03; C22C 19/07; C22C 5/06; A61C 5/00
USPC 420/435; 420/463; 420/555; 420/580; 420/456; 420/465; 420/466; 420/464; 420/587; 420/505

(57) ABSTRACT

A dental alloy contains palladium (Pd) and indium (In) for CAD/CAM machining. The dental alloy can further include one component selected from the group consisting of gold (Au), silver (Ag), nickel (Ni), cobalt (Co), and platinum (Pt). The dental alloy has a yield strength of 250 MPa to 450 MPa, breaking elongation of 2% to 8%, metal-ceramic adhesion of 20 MPa to 70 MPa, coefficient of linear thermal expansion of 14.0×10⁻⁶/K to 17.0×10⁻⁶/K, or density of 8 g/cm³ to 15 g/cm³.

### CROSS-REFERENCE TO RELATED APPLICATION

This application claims priority to and the benefit of Korean Patent Application No. 2011-0035022, filed on Apr. 15, 2011, the disclosure of which is incorporated herein by reference in its entirety.

### TECHNICAL FIELD

The present invention relates to a dental alloy, and more particularly, to a dental alloy that has physical properties such as yield strength, fracture elongation, density, etc. of an existing dental alloy and a low content of gold.

### BACKGROUND ART

In general, dental alloys refer to alloys that are used as various prostheses such as an inlay, a crown, and a core in order to restore a masticating function and a shape of a damaged tooth. The dental alloys can be classified into a noble metal alloy and a base metal alloy according to a composition, a filling alloy and a prosthetic alloy according to a purpose of use, and a casting alloy and a metal-ceramic alloy according to a type of use.

The dental alloys are used in the mouth in which various environmental changes such as temperature, acidity, and pressure changes occur. As such, firstly, the dental alloys should be able to withstand mastication pressure, be free from wear and deformation, and be similar to a tooth in rigidity, strength, and color. Secondly, the dental alloys should be safe from corrosion and discoloration in the mouth as well as noxiousness. Further, the dental alloys should meet mechanical and physical requirements such as strength, a thermal expansion coefficient, a melting range, elongation, and so on.

Materials that are widely used in the dental prosthetics to restore a missing tooth include noble metal alloys based on gold (Au), platinum (Pt), palladium (Pd), etc. and base metal alloys using Co—Cr and Ni—Cr as main components. Gold is a material that can be most ideally used in the mouth due to corrosion resistance, discoloration resistance, and biocompatibility. However, as the prices of raw materials for the dental alloy, particularly the price of gold, are increased, an economical burden weights operators and patients. As such, the need of development of more economical materials for the dental alloys is required.

Further, dental prostheses are generally made by manual casting. This work has a disadvantage in that it has a complicated process and a great burden on personnel expenditures. Furthermore, the dental prostheses may be subject to casting defects and casting shrinkage caused by lacking in harmony with wax and an investing material that are a wax pattern material and a cast material. Particularly, when an upper prosthesis for an implant is made, its restoration has a relatively greater size than that restored on a natural tooth. Thus, a casting is thick and requires a large amount of metal. In a process of homogeneously melting the large amount of metal, there is a possibility of the metal being overheated, and defects such as pin holes responsible for discoloration and corrosion are contained in a thick portion or surface of the casting. This hinders the casting from being homogeneous. To make up for this disadvantage, a computer-aided design/computer-aided manufacturing (CAD/CAM) system that is an automated and mechanized system has recently been introduced and applied to the process of making the dental restoration.

As a result of considering the above, it is an important problem that makes a dental alloy, which provides a simple manufacturing process based on the CAD/CAM system that makes up for the disadvantage of the existing system, has lower manufacturing costs than the conventional dental alloy, and maintains physical properties required for the use as the dental prosthesis.

### DISCLOSURE

### Technical Problem

The present invention is directed to a dental alloy that has lower manufacturing costs than a conventional dental alloy and maintains physical properties required for the use as a dental prosthesis.

To be specific, the present invention is directed to a dental alloy for computer-aided design/computer-aided manufacturing (CAD/CAM) machining, which includes palladium (Pd) and indium (In).

Further, the present invention is directed to a dental alloy for CAD/CAM machining, which includes palladium (Pd), indium (In), and gold (Au).

The objects of the present invention are not limited to the above, and other unmentioned objects will be clearly understood from the following description by those skilled in the art.

### Technical Solution

According to an aspect of the present invention, there is provided a dental alloy for computer-aided design/computer-aided manufacturing (CAD/CAM) machining, which includes palladium (Pd) and indium (In). In one embodiment, the dental alloy may further include silver (Ag), which includes 10 to 60 wt %. In another embodiment, the dental alloy may further include gold (Au), which includes 5 to 50 wt %. In another embodiment, the dental alloy may further include nickel (Ni), which includes 10 to 60 wt %. In another embodiment, the dental alloy may further include cobalt (Co), which includes 10 to 60 wt %. In another embodiment, the dental alloy may further include a platinum-based element, preferably platinum (Pt), which includes 10 to 60 wt %.

Further, according to another aspect of the present invention, there is provided a dental alloy for CAD/CAM machining, which includes palladium (Pd), indium (In), and gold (Au). In one embodiment, the dental alloy may further include one selected from the group consisting of platinum (Pt), iridium (Ir), rhodium (Rh), osmium (Os), ruthenium (Ru), copper (Cu), zinc (Zn), titanium (Ti), silver (Ag), nickel (Ni), and cobalt (Co).

### Advantageous Effects

According to the present invention, the dental alloy is free of corrosion or discoloration, and contains no toxic components to provide excellent biocompatibility. Furthermore, the dental alloy can be made using a simple manufacturing process while compensating for disadvantages of an existing casting method.

### BEST MODE

Above all, alloys used in the dental prosthetics should neither have chemical properties that are physiologically harmful to patients or experts and nor undergo a change in physical and chemical properties in the mouth. Further, the alloys should meet mechanical and physical requirements such as strength, conductivity, a melting range, a thermal expansion coefficient, etc. and be relatively inexpensive from an economical viewpoint.

For this reason, the present invention provides a dental alloy for computer-aided design/computer-aided manufacturing (CAD/CAM) machining, which includes palladium (Pd) and indium (In).

Hereinafter, dental alloys for CAD/CAM machining according to embodiments of the present invention will be described.

A dental alloy for CAD/CAM machining according to a first embodiment of the present invention may include 15 to 70 wt % of palladium (Pd), 10 to 60 wt % of indium (In), and 10 to 60 wt % of silver (Ag).

A dental alloy for CAD/CAM machining according to a second embodiment of the present invention may include 15 to 70 wt % of Pd, 10 to 60 wt % of In, and 5 to 50 wt % of gold (Au).

A dental alloy for CAD/CAM machining according to a third embodiment of the present invention may include 15 to 70 wt % of Pd, 10 to 60 wt % of In, and 10 to 60 wt % of nickel (Ni).

A dental alloy for CAD/CAM machining according to a fourth embodiment of the present invention may include 15 to 70 wt % of Pd, 10 to 60 wt % of In, and 10 to 60 wt % of cobalt (Co).

A dental alloy for CAD/CAM machining according to a fifth embodiment of the present invention may include 15 to 70 wt % of Pd, 10 to 60 wt % of In, and 10 to 60 wt % of a platinum-based element, preferably platinum (Pt).

A dental alloy for CAD/CAM machining according to a sixth embodiment of the present invention may include 15 to 70 wt % of Pd, 10 to 60 wt % of In, 5 to 50 wt % of gold (Au), and 0.1 to 20 wt % of one selected from the group consisting of platinum (Pt), iridium (Ir), rhodium (Rh), osmium (Os), ruthenium (Ru), copper (Cu), zinc (Zn), titanium (Ti), silver (Ag), nickel (Ni), and cobalt (Co).

The alloys of the first to sixth embodiments of the present invention have yield strength of 250 to 450 MPa, fracture elongation of 2 to 8%, metal-ceramic bonding strength of 20 to 70 MPa, a linear thermal expansion coefficient of 14.0×10⁻⁶/K to 17.0×10⁻⁶/K, or density of 8 to 15 g/cm³.

Hereinafter, exemplary embodiments are proposed to help understanding of the present invention. However, the following embodiments are merely given to more easily understand the present invention, and the present invention is not limited by the following embodiments.

### EMBODIMENTS

### Embodiment 1

### Pd—In—Ag Alloy Design

An alloy of Embodiment 1 of the present invention is an alloy to which Ag is added using Pd and In, which are metals used in an existing casting alloy as basic components. In the alloy of Embodiment 1, a ratio of Pd and In is fixed to maintain a yellow color including a golden color, and Ag is variably added within a content of 10 to 60 wt %. A composition of the alloy is given as in Table 1.

TABLE 1
Composition of alloy of Embodiment 1

| | Composition (wt %) | | |
|---|---|---|---|
| | Pd | In | Ag |
| No. 1 | 57.6 | 32.4 | 10 |
| No. 2 | 50.4 | 39.6 | 10 |
| No. 3 | 42.3 | 47.7 | 10 |
| No. 4 | 51.2 | 28.8 | 20 |
| No. 5 | 44.8 | 35.2 | 20 |
| No. 6 | 37.6 | 42.4 | 20 |
| No. 7 | 44.8 | 25.2 | 30 |
| No. 8 | 39.2 | 30.8 | 30 |
| No. 9 | 32.9 | 37.1 | 30 |
| No. 10 | 38.4 | 21.6 | 40 |
| No. 11 | 33.6 | 26.4 | 40 |
| No. 12 | 28.2 | 31.8 | 40 |
| No. 13 | 32 | 18 | 50 |
| No. 14 | 28 | 22 | 50 |
| No. 15 | 23.5 | 26.5 | 50 |
| No. 16 | 25.6 | 14.4 | 60 |
| No. 17 | 22.4 | 17.6 | 60 |
| No. 18 | 18.8 | 21.2 | 60 |

### Embodiment 2

### Pd—In—Au Alloy Design

An alloy of Embodiment 2 of the present invention is an alloy to which Au is added using Pd and In as basic components. In the alloy of Embodiment 2, a ratio of Pd and In is fixed to maintain a yellow color including a golden color, and Au is variably added within a content of 5 to 50 wt %. A composition of the alloy is given as in Table 2.

TABLE 2
Composition of alloy of Embodiment 2

| | Composition (wt %) | | |
|---|---|---|---|
| | Pd | In | Au |
| No. 1 | 66.5 | 28.5 | 5 |
| No. 2 | 52.25 | 42.75 | 5 |
| No. 3 | 38 | 57 | 5 |
| No. 4 | 63 | 27 | 10 |
| No. 5 | 49.5 | 40.5 | 10 |
| No. 6 | 36 | 54 | 10 |
| No. 7 | 56 | 24 | 20 |
| No. 8 | 44 | 36 | 20 |
| No. 9 | 32 | 48 | 20 |
| No. 10 | 49 | 21 | 30 |
| No. 11 | 38.5 | 31.5 | 30 |
| No. 12 | 28 | 42 | 30 |
| No. 13 | 42 | 18 | 40 |
| No. 14 | 33 | 27 | 40 |
| No. 15 | 24 | 36 | 40 |
| No. 16 | 35 | 15 | 50 |
| No. 17 | 27.5 | 22.5 | 50 |
| No. 18 | 20 | 30 | 50 |

### Embodiment 3

### Pd—In—Ni Alloy Design

An alloy of Embodiment 3 of the present invention is an alloy to which Ni is added using Pd and In as basic components. In the alloy of Embodiment 3, a ratio of Pd and In is fixed to maintain a yellow color including a golden color, and Ni is variably added within a content of 10 to 60 wt %. A composition of the alloy is given as in Table 3.

TABLE 3
Composition of alloy of Embodiment 3

| | Composition (wt %) | | |
|---|---|---|---|
| | Pd | In | Ni |
| No. 1 | 57.6 | 32.4 | 10 |
| No. 2 | 50.4 | 39.6 | 10 |
| No. 3 | 42.3 | 47.7 | 10 |
| No. 4 | 51.2 | 28.8 | 20 |
| No. 5 | 44.8 | 35.2 | 20 |
| No. 6 | 37.6 | 42.4 | 20 |
| No. 7 | 44.8 | 25.2 | 30 |
| No. 8 | 39.2 | 30.8 | 30 |
| No. 9 | 32.9 | 37.1 | 30 |
| No. 10 | 38.4 | 21.6 | 40 |
| No. 11 | 33.6 | 26.4 | 40 |
| No. 12 | 28.2 | 31.8 | 40 |
| No. 13 | 32 | 18 | 50 |
| No. 14 | 28 | 22 | 50 |
| No. 15 | 23.5 | 26.5 | 50 |
| No. 16 | 25.6 | 14.4 | 60 |
| No. 17 | 22.4 | 17.6 | 60 |
| No. 18 | 18.8 | 21.2 | 60 |

### Embodiment 4

### Pd—In—Co Alloy Design

An alloy of Embodiment 4 of the present invention is an alloy to which Co is added using Pd and In as basic components. In the alloy of Embodiment 4, a ratio of Pd and In is fixed to maintain a yellow color including a golden color, and Co is variably added within a content of 10 to 60 wt %. A composition of the alloy is given as in Table 4.

TABLE 4
Composition of alloy of Embodiment 4

| | Composition (wt %) | | |
|---|---|---|---|
| | Pd | In | Co |
| No. 1 | 57.6 | 32.4 | 10 |
| No. 2 | 50.4 | 39.6 | 10 |
| No. 3 | 42.3 | 47.7 | 10 |
| No. 4 | 51.2 | 28.8 | 20 |
| No. 5 | 44.8 | 35.2 | 20 |
| No. 6 | 37.6 | 42.4 | 20 |
| No. 7 | 44.8 | 25.2 | 30 |
| No. 8 | 39.2 | 30.8 | 30 |
| No. 9 | 32.9 | 37.1 | 30 |
| No. 10 | 38.4 | 21.6 | 40 |
| No. 11 | 33.6 | 26.4 | 40 |
| No. 12 | 28.2 | 31.8 | 40 |
| No. 13 | 32 | 18 | 50 |
| No. 14 | 28 | 22 | 50 |
| No. 15 | 23.5 | 26.5 | 50 |
| No. 16 | 25.6 | 14.4 | 60 |
| No. 17 | 22.4 | 17.6 | 60 |
| No. 18 | 18.8 | 21.2 | 60 |

### Embodiment 5

### Pd—In—Pt Alloy Design

An alloy of Embodiment 5 of the present invention is an alloy to which Pt is added using Pd and In as basic components. In the alloy of Embodiment 5, a ratio of Pd and In is fixed to maintain a yellow color including a golden color, and Pt is variably added within a content of 10 to 60 wt %. A composition of the alloy is given as in Table 5.

TABLE 5
Composition of alloy of Embodiment 5

| | Composition (wt %) | | |
|---|---|---|---|
| | Pd | In | Pt |
| No. 1 | 57.6 | 32.4 | 10 |
| No. 2 | 50.4 | 39.6 | 10 |
| No. 3 | 42.3 | 47.7 | 10 |
| No. 4 | 51.2 | 28.8 | 20 |
| No. 5 | 44.8 | 35.2 | 20 |
| No. 6 | 37.6 | 42.4 | 20 |
| No. 7 | 44.8 | 25.2 | 30 |
| No. 8 | 39.2 | 30.8 | 30 |
| No. 9 | 32.9 | 37.1 | 30 |
| No. 10 | 38.4 | 21.6 | 40 |
| No. 11 | 33.6 | 26.4 | 40 |
| No. 12 | 28.2 | 31.8 | 40 |
| No. 13 | 32 | 18 | 50 |
| No. 14 | 28 | 22 | 50 |
| No. 15 | 23.5 | 26.5 | 50 |
| No. 16 | 25.6 | 14.4 | 60 |
| No. 17 | 22.4 | 17.6 | 60 |
| No. 18 | 18.8 | 21.2 | 60 |

### Embodiment 6

### Design for Alloy Including Pd, in, Au, and One Selected from the Group Consisting of Pt, Ir, Rh, Os, Ru, Cu, Zn, Ti, Ag, Ni, and Co

An alloy of Embodiment 6 of the present invention is an alloy to which one selected from the group consisting of Pt, Ir, Rh, Os, Ru, Cu, Zn, Ti, Ag, Ni, and Co is added using Pd, In, and Au as basic components. In the alloy of Embodiment 6, a ratio of Pd and In is fixed to maintain a yellow color, including a golden color, and the added component is variably added within a content of 0.1 to 20 wt %. A composition of the alloy is given as in Table 6.

TABLE 6
Composition of alloy of Embodiment 6

Composition (wt %)

| | | | | One among Pt, |
|---|---|---|---|---|
| | | | | Ir, Rh, Os, |
| | | | | Ru, Cu, Zn, |
| | | | | Ti, Ag, Ni, |
| | Pd | In | Au | and Co |
| No. 1 | 66.4 | 28.5 | 5 | 0.1 |
| No. 2 | 65.8 | 28.2 | 5 | 1 |
| No. 3 | 63 | 27 | 5 | 5 |
| No. 4 | 59.5 | 25.5 | 5 | 10 |
| No. 5 | 52.2 | 42.7 | 5 | 0.1 |
| No. 6 | 51.7 | 42.3 | 5 | 1 |
| No. 7 | 49.5 | 40.5 | 5 | 5 |
| No. 8 | 46.75 | 38.25 | 5 | 10 |
| No. 9 | 38 | 56.9 | 5 | 0.1 |
| No. 10 | 37.6 | 56.4 | 5 | 1 |
| No. 11 | 36 | 54 | 5 | 5 |
| No. 12 | 34 | 51 | 5 | 10 |
| No. 13 | 62.9 | 27 | 10 | 0.1 |
| No. 14 | 62.3 | 26.7 | 10 | 1 |
| No. 15 | 59.5 | 25.5 | 10 | 5 |
| No. 16 | 56 | 24 | 10 | 10 |
| No. 17 | 49.4 | 40.5 | 10 | 0.1 |
| No. 18 | 48.95 | 40.05 | 10 | 1 |
| No. 19 | 46.75 | 38.25 | 10 | 5 |
| No. 20 | 44 | 36 | 10 | 10 |
| No. 21 | 36 | 53.9 | 10 | 0.1 |
| No. 22 | 35.6 | 53.4 | 10 | 1 |
| No. 23 | 34 | 51 | 10 | 5 |
| No. 24 | 32 | 48 | 10 | 10 |
| No. 25 | 55.9 | 24 | 20 | 0.1 |
| No. 26 | 55.3 | 23.7 | 20 | 1 |
| No. 27 | 52.5 | 22.5 | 20 | 5 |
| No. 28 | 49 | 21 | 20 | 10 |
| No. 29 | 43.9 | 36 | 20 | 0.1 |
| No. 30 | 43.45 | 35.55 | 20 | 1 |
| No. 31 | 41.25 | 33.75 | 20 | 5 |
| No. 32 | 38.5 | 31.5 | 20 | 10 |
| No. 33 | 32 | 47.9 | 20 | 0.1 |
| No. 34 | 31.6 | 47.4 | 20 | 1 |
| No. 35 | 30 | 45 | 20 | 5 |
| No. 36 | 28 | 42 | 20 | 10 |
| No. 37 | 48.9 | 28 | 30 | 0.1 |
| No. 38 | 48.3 | 20.7 | 30 | 1 |
| No. 39 | 45.5 | 19.5 | 30 | 5 |
| No. 40 | 42 | 18 | 30 | 10 |
| No. 41 | 38.4 | 31.5 | 30 | 0.1 |
| No. 42 | 37.95 | 31.05 | 30 | 1 |
| No. 43 | 35.75 | 29.25 | 30 | 5 |
| No. 44 | 33 | 27 | 30 | 10 |
| No. 45 | 28 | 41.9 | 30 | 0.1 |
| No. 46 | 27.6 | 41.4 | 30 | 1 |
| No. 47 | 26 | 39 | 30 | 5 |
| No. 48 | 24 | 36 | 30 | 10 |
| No. 49 | 41.9 | 18 | 40 | 0.1 |
| No. 50 | 41.3 | 17.7 | 40 | 1 |
| No. 51 | 38.5 | 16.5 | 40 | 5 |
| No. 52 | 35 | 15 | 40 | 10 |
| No. 53 | 32.9 | 27 | 40 | 0.1 |
| No. 54 | 32.45 | 26.55 | 40 | 1 |
| No. 55 | 30.25 | 24.75 | 40 | 5 |
| No. 56 | 27.5 | 22.5 | 40 | 10 |
| No. 57 | 24 | 35.9 | 40 | 0.1 |
| No. 58 | 23.6 | 35.4 | 40 | 1 |
| No. 59 | 22 | 33 | 40 | 5 |
| No. 60 | 20 | 30 | 40 | 10 |
| No. 61 | 34.9 | 15 | 50 | 0.1 |
| No. 62 | 34.3 | 14.7 | 50 | 1 |
| No. 63 | 31.5 | 13.5 | 50 | 5 |
| No. 64 | 28 | 12 | 50 | 10 |
| No. 65 | 27.4 | 22.5 | 50 | 0.1 |
| No. 66 | 26.95 | 22.05 | 50 | 1 |
| No. 67 | 24.75 | 20.25 | 50 | 5 |
| No. 68 | 22 | 18 | 50 | 10 |
| No. 69 | 20 | 29.9 | 50 | 0.1 |
| No. 70 | 19.6 | 29.4 | 50 | 1 |
| No. 71 | 18 | 27 | 50 | 5 |
| No. 72 | 16 | 24 | 50 | 10 |

### EXAMPLES

### Example 1

### Measurement of Yield Strength of Specimen

Dog-bone specimens having an overall length of 42 mm, a gauge length of 15 mm, and an elongation section diameter of 3 mm were prepared. A tensile test was performed on the specimens at a loading speed (cross-head speed) of 1.5 mm/min using a universal testing machine (Instron 3366, available from Instron Co, Ltd., USA). In a stress-strain curve, 0.2% offset yield strengths were obtained in unit of 0.1 MPa, and averages thereof were obtained in unit of 5 MPa. This process was equally applied to the alloys of Embodiments 1 to 6. Results of measuring the yield strengths of the alloys of Embodiments 1 to 6 are shown in Tables 7 to 9.

TABLE 7
Results of measuring yield strengths of alloys of
Embodiments 1 and 2

| | |
|---|---|
| Alloy of Embodiment 1 | Alloy of Embodiment 2 |

| | | | |
|---|---|---|---|
| No. 1 | 247 to 450 MPa | No. 1 | 240 to 451 MPa |
| No. 2 | 240 to 460 MPa | No. 2 | 245 to 454 MPa |
| No. 3 | 250 to 450 MPa | No. 3 | 244 to 456 MPa |
| No. 4 | 249 to 455 MPa | No. 4 | 246 to 458 MPa |
| No. 5 | 241 to 454 MPa | No. 5 | 247 to 460 MPa |
| No. 6 | 243 to 450 MPa | No. 6 | 247 to 467 MPa |
| No. 7 | 236 to 457 MPa | No. 7 | 248 to 468 MPa |
| No. 8 | 246 to 461 MPa | No. 8 | 251 to 460 MPa |
| No. 9 | 248 to 459 MPa | No. 9 | 249 to 461 MPa |
| No. 10 | 244 to 453 MPa | No. 10 | 243 to 455 MPa |
| No. 11 | 240 to 468 MPa | No. 11 | 241 to 453 MPa |
| No. 12 | 250 to 456 MPa | No. 12 | 239 to 453 MPa |
| No. 13 | 246 to 454 MPa | No. 13 | 235 to 455 MPa |
| No. 14 | 248 to 458 MPa | No. 14 | 243 to 456 MPa |
| No. 15 | 244 to 461 MPa | No. 15 | 245 to 454 MPa |
| No. 16 | 242 to 463 MPa | No. 16 | 248 to 460 MPa |
| No. 17 | 243 to 467 MPa | No. 17 | 247 to 461 MPa |
| No. 18 | 249 to 454 MPa | No. 18 | 246 to 469 MPa |

TABLE 8
Results of measuring yield strengths of alloys of
Embodiments 3 to 5

| Alloy of | | | | | |
|---|---|---|---|---|---|
| Embodiment 3 | | Alloy of Embodiment 4 | | Alloy of Embodiment 5 | |
| No. 1 | 249 to 451 MPa | No. 1 | 245 to 455 MPa | No. 1 | 250 to 457 MPa |
| No. 2 | 245 to 454 MPa | No. 2 | 246 to 455 MPa | No. 2 | 250 to 458 MPa |
| No. 3 | 244 to 460 MPa | No. 3 | 247 to 457 MPa | No. 3 | 248 to 459 MPa |
| No. 4 | 247 to 458 MPa | No. 4 | 244 to 458 MPa | No. 4 | 248 to 459 MPa |
| No. 5 | 250 to 462 MPa | No. 5 | 244 to 458 MPa | No. 5 | 245 to 450 MPa |
| No. 6 | 247 to 456 MPa | No. 6 | 251 to 458 MPa | No. 6 | 244 to 456 MPa |
| No. 7 | 248 to 455 MPa | No. 7 | 249 to 454 MPa | No. 7 | 243 to 454 MPa |
| No. 8 | 239 to 458 MPa | No. 8 | 245 to 453 MPa | No. 8 | 238 to 453 MPa |
| No. 9 | 245 to 459 MPa | No. 9 | 243 to 460 MPa | No. 9 | 239 to 468 MPa |
| No. 10 | 242 to 450 MPa | No. 10 | 244 to 461 MPa | No. 10 | 242 to 460 MPa |
| No. 11 | 242 to 460 MPa | No. 11 | 247 to 457 MPa | No. 11 | 246 to 455 MPa |
| No. 12 | 241 to 466 MPa | No. 12 | 248 to 450 MPa | No. 12 | 249 to 451 MPa |
| No. 13 | 247 to 454 MPa | No. 13 | 249 to 450 MPa | No. 13 | 248 to 463 MPa |
| No. 14 | 249 to 453 MPa | No. 14 | 247 to 451 MPa | No. 14 | 244 to 450 MPa |
| No. 15 | 250 to 451 MPa | No. 15 | 243 to 452 MPa | No. 15 | 250 to 452 MPa |
| No. 16 | 246 to 452 MPa | No. 16 | 240 to 451 MPa | No. 16 | 247 to 460 MPa |
| No. 17 | 243 to 450 MPa | No. 17 | 247 to 458 MPa | No. 17 | 243 to 456 MPa |
| No. 18 | 246 to 455 MPa | No. 18 | 247 to 453 MPa | No. 18 | 241 to 454 MPa |

TABLE 9
Results of measuring yield strength of alloy of Embodiment 6

| | |
|---|---|
| No. 1 | 249 to 460 MPa |
| No. 2 | 248 to 454 MPa |
| No. 3 | 244 to 456 MPa |
| No. 4 | 246 to 457 MPa |
| No. 5 | 247 to 457 MPa |
| No. 6 | 247 to 459 MPa |
| No. 7 | 242 to 454 MPa |
| No. 8 | 243 to 454 MPa |
| No. 9 | 244 to 456 MPa |
| No. 10 | 248 to 457 MPa |
| No. 11 | 246 to 460 MPa |
| No. 12 | 239 to 459 MPa |
| No. 13 | 238 to 461 MPa |
| No. 14 | 234 to 462 MPa |
| No. 15 | 248 to 463 MPa |
| No. 16 | 249 to 465 MPa |
| No. 17 | 250 to 458 MPa |
| No. 18 | 250 to 458 MPa |
| No. 19 | 245 to 458 MPa |
| No. 20 | 251 to 459 MPa |
| No. 21 | 252 to 460 MPa |
| No. 22 | 246 to 454 MPa |
| No. 23 | 245 to 453 MPa |
| No. 24 | 247 to 452 MPa |
| No. 25 | 244 to 454 MPa |
| No. 26 | 239 to 457 MPa |
| No. 27 | 239 to 456 MPa |
| No. 28 | 240 to 454 MPa |
| No. 29 | 247 to 455 MPa |
| No. 30 | 246 to 450 MPa |
| No. 31 | 246 to 450 MPa |
| No. 32 | 245 to 456 MPa |
| No. 33 | 247 to 456 MPa |
| No. 34 | 249 to 456 MPa |
| No. 35 | 251 to 450 MPa |
| No. 36 | 250 to 458 MPa |
| No. 37 | 243 to 452 MPa |
| No. 38 | 244 to 451 MPa |
| No. 39 | 244 to 453 MPa |
| No. 40 | 244 to 454 MPa |
| No. 41 | 246 to 455 MPa |
| No. 42 | 250 to 458 MPa |
| No. 43 | 243 to 460 MPa |
| No. 44 | 246 to 461 MPa |
| No. 45 | 249 to 462 MPa |
| No. 46 | 249 to 463 MPa |
| No. 47 | 245 to 463 MPa |
| No. 48 | 247 to 454 MPa |
| No. 49 | 248 to 463 MPa |
| No. 50 | 243 to 467 MPa |
| No. 51 | 249 to 468 MPa |
| No. 52 | 245 to 465 MPa |
| No. 53 | 248 to 453 MPa |
| No. 54 | 244 to 459 MPa |
| No. 55 | 243 to 458 MPa |
| No. 56 | 241 to 450 MPa |
| No. 57 | 248 to 459 MPa |
| No. 58 | 245 to 454 MPa |
| No. 59 | 250 to 460 MPa |
| No. 60 | 239 to 450 MPa |
| No. 61 | 249 to 453 MPa |
| No. 62 | 247 to 454 MPa |
| No. 63 | 241 to 451 MPa |
| No. 64 | 245 to 459 MPa |
| No. 65 | 249 to 458 MPa |
| No. 66 | 250 to 453 MPa |
| No. 67 | 246 to 458 MPa |
| No. 68 | 249 to 461 MPa |
| No. 69 | 243 to 455 MPa |
| No. 70 | 247 to 455 MPa |
| No. 71 | 250 to 457 MPa |
| No. 72 | 240 to 450 MPa |

### Example 2

### Measurement of Fracture Elongation of Specimen

Dog-bone specimens having an overall length of 42 mm, a gauge length of 15 mm, and an elongation section diameter of 3 mm were prepared. A tensile test was performed on the specimens at a loading speed (cross-head speed) of 1.5 mm/min using a universal testing machine (Instron 3366, available from Instron Co, Ltd., USA). In a stress-strain curve, elongations at break were measured in unit of 0.1%, and averages thereof were obtained in unit of 1%. This process was equally applied to the alloys of Embodiments 1 to 6. Results of measuring the fracture elongations of the alloys of Embodiments 1 to 6 are shown in Tables 10 to 12.

TABLE 10
Results of measuring fracture elongations of alloys of
Embodiments 1 and 2

| | |
|---|---|
| Alloy of | Alloy of |
| Embodiment 1 | Embodiment 2 |

| | | | |
|---|---|---|---|
| No. 1 | 1.2 to 8.5% | No. 1 | 1.5 to 8.5% |
| No. 2 | 1.4 to 8.9% | No. 2 | 1.8 to 8.6% |
| No. 3 | 1.5 to 9.0% | No. 3 | 1.7 to 8.4% |
| No. 4 | 1.1 to 8.1% | No. 4 | 1.2 to 8.3% |
| No. 5 | 1.2 to 8.4% | No. 5 | 2 to 8.8% |
| No. 6 | 1.6 to 8.4% | No. 6 | 1.9 to 8.7% |
| No. 7 | 1.9 to 9.1% | No. 7 | 1.5 to 8.3% |
| No. 8 | 1.0 to 8.2% | No. 8 | 1.1 to 8.3% |
| No. 9 | 1.5 to 8.8% | No. 9 | 1 to 8% |
| No. 10 | 1.4 to 8.3% | No. 10 | 2 to 8.3% |
| No. 11 | 1.7 to 8.4% | No. 11 | 1.5 to 8.1% |
| No. 12 | 1.8 to 8.2% | No. 12 | 1.4 to 8.7% |
| No. 13 | 2 to 8.9% | No. 13 | 1.8 to 8.6% |
| No. 14 | 1.3 to 8.4% | No. 14 | 1.3 to 8.4% |
| No. 15 | 1.1 to 8% | No. 15 | 1.9 to 8.8% |
| No. 16 | 1.5 to 9% | No. 16 | 1.7 to 8.9% |
| No. 17 | 1.8 to 8.6% | No. 17 | 1.9 to 9% |
| No. 18 | 1.5 to 8.5% | No. 18 | 1.4 to 8.3% |

TABLE 11
Results of measuring fracture elongations of alloys of
Embodiments 3 to 5

| Alloy of | | Alloy of | | Alloy of | |
|---|---|---|---|---|---|
| Embodiment 3 | | Embodiment 4 | | Embodiment 5 | |
| No. 1 | 1.4 to 8.3% | No. 1 | 1.5 to 8.5% | No. 1 | 1.6 to 8.3% |
| No. 2 | 2 to 8.3% | No. 2 | 1.9 to 8.5% | No. 2 | 1.2 to 8.1% |
| No. 3 | 1.9 to 8.6% | No. 3 | 1.3 to 8.5% | No. 3 | 1.7 to 8.4% |
| No. 4 | 1.4 to 8.3% | No. 4 | 1.8 to 8.6% | No. 4 | 1.9 to 9% |
| No. 5 | 1.8 to 8.9% | No. 5 | 1.5 to 8.4% | No. 5 | 1.6 to 8.3% |
| No. 6 | 1.4 to 8.2% | No. 6 | 1.9 to 9% | No. 6 | 1.7 to 8.9% |
| No. 7 | 1.5 to 8.4% | No. 7 | 2 to 8.3% | No. 7 | 1.4 to 8.3% |
| No. 8 | 1.1 to 8.1% | No. 8 | 1.3 to 8.2% | No. 8 | 2 to 9.1% |
| No. 9 | 1 to 8% | No. 9 | 1.5 to 8.5% | No. 9 | 1.5 to 8.4% |
| No. 10 | 2 to 9% | No. 10 | 1.6 to 8.3% | No. 10 | 1.6 to 8.3% |
| No. 11 | 1.4 to 8.3% | No. 11 | 1.7 to 8.4% | No. 11 | 1.3 to 8.5% |
| No. 12 | 1.7 to 8.5% | No. 12 | 1.2 to 8.7% | No. 12 | 1.4 to 8.6% |
| No. 13 | 1.5 to 8.4% | No. 13 | 1.1 to 8.2% | No. 13 | 1.5 to 8.7% |
| No. 14 | 1.8 to 8.6% | No. 14 | 1.4 to 8.3% | No. 14 | 1.6 to 8.9% |
| No. 15 | 1.6 to 8.5% | No. 15 | 1 to 8% | No. 15 | 1.1 to 8% |
| No. 16 | 1.2 to 8.6% | No. 16 | 1.3 to 8.1% | No. 16 | 1.3 to 8.3% |
| No. 17 | 1.5 to 8.5% | No. 17 | 1.6 to 8.3% | No. 17 | 1.5 to 8.4% |
| No. 18 | 1.4 to 8.1% | No. 18 | 1.9 to 8.7% | No. 18 | 1.7 to 8.2% |

TABLE 12
Results of measuring fracture elongation of alloy of
Embodiment 6

| | |
|---|---|
| No. 1 | 1.5 to 8.5% |
| No. 2 | 1.9 to 8.5% |
| No. 3 | 1.3 to 8.5% |
| No. 4 | 1.8 to 8.6% |
| No. 5 | 1.5 to 8.4% |
| No. 6 | 1.9 to 9% |
| No. 7 | 2 to 8.3% |
| No. 8 | 1.3 to 8.2% |
| No. 9 | 1.5 to 8.5% |
| No. 10 | 1.6 to 8.3% |
| No. 11 | 1.7 to 8.4% |
| No. 12 | 1.2 to 8.7% |
| No. 13 | 1.1 to 8.2% |
| No. 14 | 1.4 to 8.3% |
| No. 15 | 1 to 8% |
| No. 16 | 1.3 to 8.1% |
| No. 17 | 1.6 to 8.3% |
| No. 18 | 1.9 to 8.7% |
| No. 19 | 1.5 to 8.5% |
| No. 20 | 1.6 to 8.3% |
| No. 21 | 1.2 to 8.1% |
| No. 22 | 1.7 to 8.4% |
| No. 23 | 1.9 to 9% |
| No. 24 | 1.6 to 8.3% |
| No. 25 | 1.7 to 8.9% |
| No. 26 | 1.4 to 8.3% |
| No. 27 | 2 to 9.1% |
| No. 28 | 1.5 to 8.4% |
| No. 29 | 1.6 to 8.3% |
| No. 30 | 1.3 to 8.5% |
| No. 31 | 1.4 to 8.6% |
| No. 32 | 1.5 to 8.7% |
| No. 33 | 1.6 to 8.9% |
| No. 34 | 1.1 to 8% |
| No. 35 | 1.3 to 8.3% |
| No. 36 | 1.5 to 8.4% |
| No. 37 | 1.5 to 8.5% |
| No. 38 | 1.1 to 8% |
| No. 39 | 1.9 to 9% |
| No. 40 | 2 to 8.4% |
| No. 41 | 1.5 to 8.1% |
| No. 42 | 1.6 to 8.3% |
| No. 43 | 1.8 to 8.2% |
| No. 44 | 1.2 to 8% |
| No. 45 | 1.6 to 8.4% |
| No. 46 | 1.8 to 8.6% |
| No. 47 | 1.7 to 8.5% |
| No. 48 | 1.4 to 8.8% |
| No. 49 | 1.4 to 8.3% |
| No. 50 | 2 to 8.3% |
| No. 51 | 1.9 to 8.6% |
| No. 52 | 1.4 to 8.3% |
| No. 53 | 1.8 to 8.9% |
| No. 54 | 1.4 to 8.2% |
| No. 55 | 1.5 to 8.4% |
| No. 56 | 1.1 to 8.1% |
| No. 57 | 1 to 8% |
| No. 58 | 2 to 9% |
| No. 59 | 1.4 to 8.3% |
| No. 60 | 1.7 to 8.5% |
| No. 61 | 1.5 to 8.4% |
| No. 62 | 1.8 to 8.6% |
| No. 63 | 1.6 to 8.5% |
| No. 64 | 1.2 to 8.6% |
| No. 65 | 1.5 to 8.5% |
| No. 66 | 1.4 to 8.1% |
| No. 67 | 2 to 8.8% |
| No. 68 | 1.9 to 8.9% |
| No. 69 | 1.5 to 8.5% |
| No. 70 | 1.6 to 8.7% |
| No. 71 | 1.3 to 8.4% |
| No. 72 | 1.1 to 8% |

### Example 3

### Measurement of Elastic Modulus of Specimen

Dog-bone specimens having an overall length of 42 mm, a gauge length of 15 mm, and an elongation section diameter of 3 mm were prepared. A tensile test was performed on the specimens at a loading speed (cross-head speed) of 1.5 mm/min using a universal testing machine (Instron 3366, available from Instron Co, Ltd., USA). In a stress-strain curve, elastic moduli were measured. This process was equally applied to the alloys of Embodiments 1 to 6. Results of measuring the elastic moduli of the alloys of Embodiments 1 to 6 are shown in Tables 13 to 15.

TABLE 13
Results of measuring elastic moduli of alloys of
Embodiments 1 and 2

| | |
|---|---|
| Alloy of | Alloy of |
| Embodiment 1 | Embodiment 2 |

| | | | |
|---|---|---|---|
| No. 1 | 72 to 155 GPa | No. 1 | 74 to 152 GPa |
| No. 2 | 78 to 156 GPa | No. 2 | 75 to 155 GPa |
| No. 3 | 80 to 160 GPa | No. 3 | 77 to 156 GPa |
| No. 4 | 75 to 156 GPa | No. 4 | 74 to 153 GPa |
| No. 5 | 72 to 154 GPa | No. 5 | 73 to 158 GPa |
| No. 6 | 79 to 158 GPa | No. 6 | 74 to 154 GPa |
| No. 7 | 75 to 156 GPa | No. 7 | 76 to 157 GPa |
| No. 8 | 73 to 155 GPa | No. 8 | 78 to 160 GPa |
| No. 9 | 72 to 153 GPa | No. 9 | 79 to 159 GPa |
| No. 10 | 77 to 157 GPa | No. 10 | 74 to 154 GPa |
| No. 11 | 75 to 153 GPa | No. 11 | 73 to 152 GPa |
| No. 12 | 74 to 155 GPa | No. 12 | 71 to 151 GPa |
| No. 13 | 72 to 150 GPa | No. 13 | 72 to 153 GPa |
| No. 14 | 71 to 151 GPa | No. 14 | 70 to 151 GPa |
| No. 15 | 70 to 150 GPa | No. 15 | 75 to 154 GPa |
| No. 16 | 78 to 156 GPa | No. 16 | 77 to 153 GPa |
| No. 17 | 77 to 152 GPa | No. 17 | 72 to 154 GPa |
| No. 18 | 74 to 151 GPa | No. 18 | 73 to 150 GPa |

TABLE 14
Results of measuring elastic moduli of alloys of
Embodiments 3 to 5

| Alloy of | | Alloy of | | Alloy of | |
|---|---|---|---|---|---|
| Embodiment 3 | | Embodiment 4 | | Embodiment 5 | |
| No. 1 | 75 to 155 GPa | No. 1 | 74 to 153 GPa | No. 1 | 74 to 153 GPa |
| No. 2 | 72 to 151 GPa | No. 2 | 77 to 156 GPa | No. 2 | 71 to 151 GPa |
| No. 3 | 69 to 150 GPa | No. 3 | 78 to 157 GPa | No. 3 | 73 to 154 GPa |
| No. 4 | 70 to 153 GPa | No. 4 | 74 to 154 GPa | No. 4 | 79 to 155 GPa |
| No. 5 | 79 to 159 GPa | No. 5 | 76 to 152 GPa | No. 5 | 77 to 156 GPa |
| No. 6 | 80 to 161 GPa | No. 6 | 72 to 150 GPa | No. 6 | 75 to 154 GPa |
| No. 7 | 72 to 152 GPa | No. 7 | 71 to 151 GPa | No. 7 | 70 to 151 GPa |
| No. 8 | 75 to 154 GPa | No. 8 | 76 to 154 GPa | No. 8 | 69 to 152 GPa |
| No. 9 | 76 to 156 GPa | No. 9 | 77 to 156 GPa | No. 9 | 72 to 152 GPa |
| No. 10 | 79 to 158 GPa | No. | 69 to 151 GPa | No. | 73 to 151 GPa |
| | | 10 | | 10 | |
| No. 11 | 75 to 152 GPa | No. | 77 to 159 GPa | No. | 75 to 156 GPa |
| | | 11 | | 11 | |
| No. 12 | 72 to 153 GPa | No. | 80 to 160 GPa | No. | 78 to 159 GPa |
| | | 12 | | 12 | |
| No. 13 | 74 to 154 GPa | No. | 75 to 154 GPa | No. | 77 to 155 GPa |
| | | 13 | | 13 | |
| No. 14 | 77 to 157 GPa | No. | 76 to 154 GPa | No. | 74 to 152 GPa |
| | | 14 | | 14 | |
| No. 15 | 74 to 154 GPa | No. | 79 to 158 GPa | No. | 72 to 151 GPa |
| | | 15 | | 15 | |
| No. 16 | 76 to 158 GPa | No. | 71 to 150 GPa | No. | 77 to 158 GPa |
| | | 16 | | 16 | |
| No. 17 | 70 to 152 GPa | No. | 75 to 154 GPa | No. | 75 to 156 GPa |
| | | 17 | | 17 | |
| No. 18 | 78 to 158 GPa | No. | 77 to 158 GPa | No. | 79 to 158 GPa |
| | | 18 | | 18 | |

TABLE 15
Results of measuring elastic modulus of alloy of
Embodiment 6

| | |
|---|---|
| No. 1 | 74 to 153 GPa |
| No. 2 | 77 to 156 GPa |
| No. 3 | 78 to 157 GPa |
| No. 4 | 74 to 154 GPa |
| No. 5 | 76 to 152 GPa |
| No. 6 | 72 to 150 GPa |
| No. 7 | 71 to 151 GPa |
| No. 8 | 76 to 154 GPa |
| No. 9 | 77 to 156 GPa |
| No. 10 | 69 to 151 GPa |
| No. 11 | 77 to 159 GPa |
| No. 12 | 80 to 160 GPa |
| No. 13 | 75 to 154 GPa |
| No. 14 | 76 to 154 GPa |
| No. 15 | 79 to 158 GPa |
| No. 16 | 71 to 150 GPa |
| No. 17 | 75 to 154 GPa |
| No. 18 | 77 to 158 GPa |
| No. 19 | 77 to 156 GPa |
| No. 20 | 75 to 154 GPa |
| No. 21 | 70 to 151 GPa |
| No. 22 | 69 to 150 GPa |
| No. 23 | 72 to 152 GPa |
| No. 24 | 73 to 151 GPa |
| No. 25 | 75 to 156 GPa |
| No. 26 | 78 to 159 GPa |
| No. 27 | 77 to 155 GPa |
| No. 28 | 79 to 159 GPa |
| No. 29 | 74 to 154 GPa |
| No. 30 | 73 to 152 GPa |
| No. 31 | 71 to 151 GPa |
| No. 32 | 72 to 153 GPa |
| No. 33 | 70 to 151 GPa |
| No. 34 | 75 to 154 GPa |
| No. 35 | 77 to 153 GPa |
| No. 36 | 72 to 154 GPa |
| No. 37 | 73 to 150 GPa |
| No. 38 | 69 to 150 GPa |
| No. 39 | 70 to 153 GPa |
| No. 40 | 79 to 159 GPa |
| No. 41 | 80 to 161 GPa |
| No. 42 | 72 to 152 GPa |
| No. 43 | 75 to 154 GPa |
| No. 44 | 76 to 156 GPa |
| No. 45 | 79 to 158 GPa |
| No. 46 | 75 to 152 GPa |
| No. 47 | 72 to 153 GPa |
| No. 48 | 74 to 154 GPa |
| No. 49 | 77 to 157 GPa |
| No. 50 | 74 to 154 GPa |
| No. 51 | 76 to 158 GPa |
| No. 52 | 70 to 152 GPa |
| No. 53 | 78 to 158 GPa |
| No. 54 | 77 to 154 GPa |
| No. 55 | 80 to 160 GPa |
| No. 56 | 75 to 156 GPa |
| No. 57 | 72 to 154 GPa |
| No. 58 | 79 to 158 GPa |
| No. 59 | 75 to 156 GPa |
| No. 60 | 73 to 155 GPa |
| No. 61 | 72 to 153 GPa |
| No. 62 | 77 to 157 GPa |
| No. 63 | 75 to 153 GPa |
| No. 64 | 74 to 155 GPa |
| No. 65 | 72 to 150 GPa |
| No. 66 | 71 to 151 GPa |
| No. 67 | 70 to 150 GPa |
| No. 68 | 78 to 156 GPa |
| No. 69 | 77 to 152 GPa |
| No. 70 | 74 to 151 GPa |
| No. 71 | 71 to 150 GPa |
| No. 72 | 79 to 160 GPa |

### Example 4

### Measurement of Linear Thermal Expansion Coefficient of Specimen

Two specimens having a diameter of 5 mm and a height of mm were prepared, and a linear thermal expansion coefficient was measured for the two specimens from 25° C. to 550° C. at a rate of 5° C./min using a thermomechanical analyzer (TMA 2940, available from TA Instrument, USA). That is, an average thermal expansion coefficient was recorded by rounding off an average value of the linear thermal expansion coefficients α from 25° C. to 500° C. to a level of 0.1×10⁻⁶/K. This process was equally applied to the alloys of Embodiments 1 to 6. Results of measuring the linear thermal expansion coefficients of the alloys of Embodiments 1 to 6 are shown in Tables 16 to 18.

TABLE 16
Results of measuring linear thermal expansion
coefficients of alloys of Embodiments 1 and 2

| Alloy of Embodiment 1 | | Alloy of Embodiment 2 | |
|---|---|---|---|
| No. 1 | 13.5 to 17.4 × 10⁻⁶/K | No. 1 | 13.4 to 17.3 × 10⁻⁶/K |
| No. 2 | 13.2 to 17.1 × 10⁻⁶/K | No. 2 | 13.5 to 17.4 × 10⁻⁶/K |
| No. 3 | 13.9 to 17.7 × 10⁻⁶/K | No. 3 | 13.8 to 17.7 × 10⁻⁶/K |
| No. 4 | 13.5 to 17.4 × 10⁻⁶/K | No. 4 | 13.7 to 17.5 × 10⁻⁶/K |
| No. 5 | 13.1 to 17 × 10⁻⁶/K | No. 5 | 13.2 to 17.4 × 10⁻⁶/K |
| No. 6 | 13 to 17.1 × 10⁻⁶/K | No. 6 | 13.4 to 17.5 × 10⁻⁶/K |
| No. 7 | 13.5 to 17.2 × 10⁻⁶/K | No. 7 | 13.5 to 17.4 × 10⁻⁶/K |
| No. 8 | 13.2 to 17.1 × 10⁻⁶/K | No. 8 | 13.8 to 17.6 × 10⁻⁶/K |
| No. 9 | 13.9 to 17.7 × 10⁻⁶/K | No. 9 | 14 to 17.9 × 10⁻⁶/K |
| No. 10 | 13.7 to 17.6 × 10⁻⁶/K | No. 10 | 13.4 to 17.3 × 10⁻⁶/K |
| No. 11 | 13.4 to 17.5 × 10⁻⁶/K | No. 11 | 13.8 to 17.7 × 10⁻⁶/K |
| No. 12 | 13.5 to 17.6 × 10⁻⁶/K | No. 12 | 13.5 to 17.4 × 10⁻⁶/K |
| No. 13 | 13.8 to 17.7 × 10⁻⁶/K | No. 13 | 13.9 to 17.8 × 10⁻⁶/K |
| No. 14 | 13.4 to 17.2 × 10⁻⁶/K | No. 14 | 13.4 to 17.4 × 10⁻⁶/K |
| No. 15 | 13.8 to 17.7 × 10⁻⁶/K | No. 15 | 13.5 to 17.2 × 10⁻⁶/K |
| No. 16 | 13.6 to 17.4 × 10⁻⁶/K | No. 16 | 13.9 to 18 × 10⁻⁶/K |
| No. 17 | 14 to 17.9 × 10⁻⁶/K | No. 17 | 13.4 to 17.3 × 10⁻⁶/K |
| No. 18 | 13.4 to 17.5 × 10⁻⁶/K | No. 18 | 13.7 to 17.5 × 10⁻⁶/K |

TABLE 17
Results of measuring linear thermal expansion
coefficients of alloys of Embodiments 3 to 5

| Alloy of | | Alloy of | | Alloy of | |
|---|---|---|---|---|---|
| Embodiment 3 | | Embodiment 4 | | Embodiment 5 | |
| No. 1 | 13.5 to | No. 1 | 13.4 to | No. 1 | 13.1 to |
| | 17.4 × 10⁻⁶/K | | 17.5 × 10⁻⁶/K | | 17.1 × 10⁻⁶/K |
| No. 2 | 13.2 to | No. 2 | 13.8 to | No. 2 | 13.4 to |
| | 17 × 10⁻⁶/K | | 17.7 × 10⁻⁶/K | | 17.5 × 10⁻⁶/K |
| No. 3 | 13.9 to | No. 3 | 13.7 to | No. 3 | 13.6 to |
| | 17.8 × 10⁻⁶/K | | 17.5 × 10⁻⁶/K | | 17.7 × 10⁻⁶/K |
| No. 4 | 13.7 to | No. 4 | 13.5 to | No. 4 | 13.7 to |
| | 17.4 × 10⁻⁶/K | | 17.4 × 10⁻⁶/K | | 17.6 × 10⁻⁶/K |
| No. 5 | 13.2 to | No. 5 | 13.1 to | No. 5 | 13.5 to |
| | 17.1 × 10⁻⁶/K | | 17.1 × 10⁻⁶/K | | 17.4 × 10⁻⁶/K |
| No. 6 | 13.8 to | No. 6 | 13.9 to | No. 6 | 13.3 to |
| | 17.7 × 10⁻⁶/K | | 17.8 × 10⁻⁶/K | | 17.2 × 10⁻⁶/K |
| No. 7 | 13.5 to | No. 7 | 13.8 to | No. 7 | 13.9 to |
| | 17.4 × 10⁻⁶/K | | 18 × 10⁻⁶/K | | 18 × 10⁻⁶/K |
| No. 8 | 13.7 to | No. 8 | 13.7 to | No. 8 | 14 to |
| | 17.6 × 10⁻⁶/K | | 17.4 × 10⁻⁶/K | | 18.1 × 10⁻⁶/K |
| No. 9 | 13.4 to | No. 9 | 13.5 to | No. 9 | 13.7 to |
| | 17.1 × 10⁻⁶/K | | 17.6 × 10⁻⁶/K | | 17.3 × 10⁻⁶/K |
| No. | 13.1 to | No. | 13.7 to | No. | 13.8 to |
| 10 | 17 × 10⁻⁶/K | 10 | 17.7 × 10⁻⁶/K | 10 | 17.7 × 10⁻⁶/K |
| No. | 13.2 to | No. | 13.5 to | No. | 13.6 to |
| 11 | 17.1 × 10⁻⁶/K | 11 | 17.6 × 10⁻⁶/K | 11 | 17.6 × 10⁻⁶/K |
| No. | 13 to | No. | 13.7 to | No. | 13.2 to |
| 12 | 17 × 10⁻⁶/K | 12 | 17.4 × 10⁻⁶/K | 12 | 17.1 × 10⁻⁶/K |
| No. | 13.4 to | No. | 13.2 to | No. | 13 to |
| 13 | 17.3 × 10⁻⁶/K | 13 | 17.1 × 10⁻⁶/K | 13 | 17.1 × 10⁻⁶/K |
| No. | 13.6 to | No. | 13 to | No. | 13.6 to |
| 14 | 17.5 × 10⁻⁶/K | 14 | 17.1 × 10⁻⁶/K | 14 | 17.4 × 10⁻⁶/K |
| No. | 13.8 to | No. | 13.2 to | No. | 13.7 to |
| 15 | 17.7 × 10⁻⁶/K | 15 | 17.3 × 10⁻⁶/K | 15 | 17.8 × 10⁻⁶/K |
| No. | 13.4 to | No. | 13.4 to | No. | 13.9 to |
| 16 | 17.3 × 10⁻⁶/K | 16 | 17.8 × 10⁻⁶/K | 16 | 18 × 10⁻⁶/K |
| No. | 13.5 to | No. | 13.7 to | No. | 13.5 to |
| 17 | 17.6 × 10⁻⁶/K | 17 | 17.5 × 10⁻⁶/K | 17 | 17.4 × 10⁻⁶/K |
| No. | 13.1 to | No. | 13.3 to | No. | 13.7 to |
| 18 | 17.2 × 10⁻⁶/K | 18 | 17.1 × 10⁻⁶/K | 18 | 17.8 × 10⁻⁶/K |

TABLE 18
Results of measuring linear thermal expansion coefficient
of alloy of Embodiment 6

| | |
|---|---|
| No. 1 | 13.8 to 17.7 × 10⁻⁶/K |
| No. 2 | 13.4 to 17.3 × 10⁻⁶/K |
| No. 3 | 14 to 18 × 10⁻⁶/K |
| No. 4 | 13.2 to 17.1 × 10⁻⁶/K |
| No. 5 | 13.4 to 17.5 × 10⁻⁶/K |
| No. 6 | 13.8 to 17.7 × 10⁻⁶/K |
| No. 7 | 13.7 to 17.5 × 10⁻⁶/K |
| No. 8 | 13.5 to 17.4 × 10⁻⁶/K |
| No. 9 | 13.1 to 17.2 × 10⁻⁶/K |
| No. 10 | 12.9 to 17.1 × 10⁻⁶/K |
| No. 11 | 13.5 to 17.1 × 10⁻⁶/K |
| No. 12 | 13.4 to 17.5 × 10⁻⁶/K |
| No. 13 | 13.8 to 17.7 × 10⁻⁶/K |
| No. 14 | 13.7 to 17.5 × 10⁻⁶/K |
| No. 15 | 13.5 to 17.4 × 10⁻⁶/K |
| No. 16 | 13.1 to 17.1 × 10⁻⁶/K |
| No. 17 | 13.9 to 17.8 × 10⁻⁶/K |
| No. 18 | 13.8 to 18 × 10⁻⁶/K |
| No. 19 | 13.7 to 17.4 × 10⁻⁶/K |
| No. 20 | 13.5 to 17.6 × 10⁻⁶/K |
| No. 21 | 13.7 to 17.7 × 10⁻⁶/K |
| No. 22 | 13.5 to 17.6 × 10⁻⁶/K |
| No. 23 | 13.7 to 17.4 × 10⁻⁶/K |
| No. 24 | 13.2 to 17.1 × 10⁻⁶/K |
| No. 25 | 13 to 17.1 × 10⁻⁶/K |
| No. 26 | 13.2 to 17.3 × 10⁻⁶/K |
| No. 27 | 13.7 to 17.5 × 10⁻⁶/K |
| No. 28 | 13.2 to 17.4 × 10⁻⁶/K |
| No. 29 | 13.4 to 17.5 × 10⁻⁶/K |
| No. 30 | 13.5 to 17.4 × 10⁻⁶/K |
| No. 31 | 13.8 to 17.6 × 10⁻⁶/K |
| No. 32 | 14 to 17.9 × 10⁻⁶/K |
| No. 33 | 13.4 to 17.3 × 10⁻⁶/K |
| No. 34 | 13.8 to 17.7 × 10⁻⁶/K |
| No. 35 | 13.5 to 17.4 × 10⁻⁶/K |
| No. 36 | 13.8 to 17.8 × 10⁻⁶/K |
| No. 37 | 13.5 to 17.4 × 10⁻⁶/K |
| No. 38 | 13.1 to 17 × 10⁻⁶/K |
| No. 39 | 13 to 17.1 × 10⁻⁶/K |
| No. 40 | 13.5 to 17.2 × 10⁻⁶/K |
| No. 41 | 13.2 to 17.1 × 10⁻⁶/K |
| No. 42 | 13.9 to 17.7 × 10⁻⁶/K |
| No. 43 | 13.7 to 17.6 × 10⁻⁶/K |
| No. 44 | 13.4 to 17.5 × 10⁻⁶/K |
| No. 45 | 13.5 to 17.6 × 10⁻⁶/K |
| No. 46 | 13.8 to 17.7 × 10⁻⁶/K |
| No. 47 | 13.4 to 17.2 × 10⁻⁶/K |
| No. 48 | 13.5 to 17.4 × 10⁻⁶/K |
| No. 49 | 13.7 to 17.6 × 10⁻⁶/K |
| No. 50 | 13.4 to 17.1 × 10⁻⁶/K |
| No. 51 | 13.1 to 17 × 10⁻⁶/K |
| No. 52 | 13.2 to 17.1 × 10⁻⁶/K |
| No. 53 | 13 to 17 × 10⁻⁶/K |
| No. 54 | 13.4 to 17.3 × 10⁻⁶/K |
| No. 55 | 13.6 to 17.5 × 10⁻⁶/K |
| No. 56 | 13.8 to 17.7 × 10⁻⁶/K |
| No. 57 | 13.4 to 17.3 × 10⁻⁶/K |
| No. 58 | 13.5 to 17.6 × 10⁻⁶/K |
| No. 59 | 13.1 to 17.2 × 10⁻⁶/K |
| No. 60 | 13.6 to 17.7 × 10⁻⁶/K |
| No. 61 | 13.7 to 17.6 × 10⁻⁶/K |
| No. 62 | 13.5 to 17.4 × 10⁻⁶/K |
| No. 63 | 13.3 to 17.2 × 10⁻⁶/K |
| No. 64 | 13.9 to 18 × 10⁻⁶/K |
| No. 65 | 14 to 18.1 × 10⁻⁶/K |
| No. 66 | 13.7 to 17.3 × 10⁻⁶/K |
| No. 67 | 13.8 to 17.7 × 10⁻⁶/K |
| No. 68 | 13.6 to 17.6 × 10⁻⁶/K |
| No. 69 | 13.2 to 17.1 × 10⁻⁶/K |
| No. 70 | 13 to 17.1 × 10⁻⁶/K |
| No. 71 | 13.6 to 17.4 × 10⁻⁶/K |
| No. 72 | 13.7 to 17.8 × 10⁻⁶/K |

### Example 5

### Measurement of Metal-Ceramic Bonding Strength of Specimen

Specimens having dimensions of (25±1) mm×(3±0.1) mm×(0.5±0.05) mm were prepared, and a three point bending test was performed on the specimens at a loading speed (cross-head speed) of 1.5 mm/min using a universal testing machine (Instron 3366, available from Instron Co, Ltd., USA). Thereby, a load F_{fail} (N) was measured when a ceramic portion was broken. Bonding strength Tb (MPa) was calculated according to the following equation. This process was equally applied to the alloys of Embodiments 1 to 6.

Tb=kF_{fail}

where k indicates the elastic modulus (130 GPa)

Results of measuring the metal-ceramic bonding strengths of the alloys of Embodiments 1 to 6 are shown in Tables 19 to 21.

TABLE 19
Results of measuring metal-ceramic bonding strengths of
alloys of Embodiments 1 and 2

| | |
|---|---|
| Alloy of | Alloy of |
| Embodiment 1 | Embodiment 2 |

| | | | |
|---|---|---|---|
| No. 1 | 15 to 72 MPa | No. 1 | 17 to 73 MPa |
| No. 2 | 18 to 74 MPa | No. 2 | 16 to 72 MPa |
| No. 3 | 19 to 77 MPa | No. 3 | 18 to 76 MPa |
| No. 4 | 26 to 74 MPa | No. 4 | 19 to 75 MPa |
| No. 5 | 12 to 70 MPa | No. 5 | 18 to 77 MPa |
| No. 6 | 13 to 72 MPa | No. 6 | 14 to 75 MPa |
| No. 7 | 15 to 74 MPa | No. 7 | 13 to 72 MPa |
| No. 8 | 10 to 70 MPa | No. 8 | 17 to 75 MPa |
| No. 9 | 12 to 71 MPa | No. 9 | 16 to 72 MPa |
| No. 10 | 13 to 72 MPa | No. 10 | 13 to 72 MPa |
| No. 11 | 19 to 78 MPa | No. 11 | 19 to 78 MPa |
| No. 12 | 20 to 81 MPa | No. 12 | 12 to 71 MPa |
| No. 13 | 16 to 75 MPa | No. 13 | 11 to 72 MPa |
| No. 14 | 12 to 71 MPa | No. 14 | 14 to 75 MPa |
| No. 15 | 11 to 70 MPa | No. 15 | 16 to 77 MPa |
| No. 16 | 10 to 72 MPa | No. 16 | 15 to 74 MPa |
| No. 17 | 16 to 77 MPa | No. 17 | 16 to 77 MPa |
| No. 18 | 17 to 75 MPa | No. 18 | 19 to 80 MPa |

TABLE 20
Results of measuring metal-ceramic bonding strengths of
alloys of Embodiments 3 to 5

| Alloy of | | Alloy of | | Alloy of | |
|---|---|---|---|---|---|
| Embodiment 3 | | Embodiment 4 | | Embodiment 5 | |
| No. 1 | 14 to 73 MPa | No. 1 | 12 to 71 MPa | No. 1 | 15 to 73 MPa |
| No. 2 | 13 to 74 MPa | No. 2 | 15 to 73 MPa | No. 2 | 11 to 71 MPa |
| No. 3 | 15 to 74 MPa | No. 3 | 17 to 75 MPa | No. 3 | 12 to 71 MPa |
| No. 4 | 20 to 81 MPa | No. 4 | 16 to 74 MPa | No. 4 | 15 to 73 MPa |
| No. 5 | 17 to 76 MPa | No. 5 | 19 to 79 MPa | No. 5 | 13 to 72 MPa |
| No. 6 | 11 to 70 MPa | No. 6 | 20 to 81 MPa | No. 6 | 17 to 75 MPa |
| No. 7 | 12 to 71 MPa | No. 7 | 13 to 75 MPa | No. 7 | 16 to 73 MPa |
| No. 8 | 15 to 73 MPa | No. 8 | 14 to 71 MPa | No. 8 | 19 to 78 MPa |
| No. 9 | 13 to 75 MPa | No. 9 | 19 to 77 MPa | No. 9 | 18 to 72 MPa |
| No. 10 | 14 to 72 MPa | No. | 17 to 75 MPa | No. | 16 to 74 MPa |
| | | 10 | | 10 | |
| No. 11 | 17 to 78 MPa | No. | 16 to 72 MPa | No. | 14 to 73 MPa |
| | | 11 | | 11 | |
| No. 12 | 19 to 77 MPa | No. | 12 to 74 MPa | No. | 19 to 81 MPa |
| | | 12 | | 12 | |
| No. 13 | 15 to 72 MPa | No. | 15 to 71 MPa | No. | 16 to 75 MPa |
| | | 13 | | 13 | |
| No. 14 | 14 to 73 MPa | No. | 17 to 76 MPa | No. | 13 to 72 MPa |
| | | 14 | | 14 | |
| No. 15 | 11 to 71 MPa | No. | 16 to 75 MPa | No. | 11 to 70 MPa |
| | | 15 | | 15 | |
| No. 16 | 19 to 78 MPa | No. | 10 to 70 MPa | No. | 16 to 75 MPa |
| | | 16 | | 16 | |
| No. 17 | 15 to 73 MPa | No. | 11 to 71 MPa | No. | 13 to 72 MPa |
| | | 17 | | 17 | |
| No. 18 | 13 to 72 MPa | No. | 13 to 72 MPa | No. | 14 to 77 MPa |
| | | 18 | | 18 | |

TABLE 21
Results of measuring metal-ceramic bonding strength of
alloy of Embodiment 6

| | |
|---|---|
| No. 1 | 11 to 71 MPa |
| No. 2 | 15 to 74 MPa |
| No. 3 | 12 to 73 MPa |
| No. 4 | 17 to 75 MPa |
| No. 5 | 17 to 73 MPa |
| No. 6 | 16 to 72 MPa |
| No. 7 | 18 to 76 MPa |
| No. 8 | 19 to 75 MPa |
| No. 9 | 18 to 77 MPa |
| No. 10 | 14 to 75 MPa |
| No. 11 | 13 to 72 MPa |
| No. 12 | 17 to 75 MPa |
| No. 13 | 16 to 72 MPa |
| No. 14 | 13 to 72 MPa |
| No. 15 | 19 to 78 MPa |
| No. 16 | 12 to 71 MPa |
| No. 17 | 11 to 72 MPa |
| No. 18 | 14 to 75 MPa |
| No. 19 | 16 to 77 MPa |
| No. 20 | 15 to 74 MPa |
| No. 21 | 16 to 77 MPa |
| No. 22 | 19 to 80 MPa |
| No. 23 | 14 to 71 MPa |
| No. 24 | 19 to 77 MPa |
| No. 25 | 17 to 75 MPa |
| No. 26 | 16 to 72 MPa |
| No. 27 | 12 to 74 MPa |
| No. 28 | 15 to 71 MPa |
| No. 29 | 17 to 76 MPa |
| No. 30 | 16 to 75 MPa |
| No. 31 | 10 to 70 MPa |
| No. 32 | 11 to 71 MPa |
| No. 33 | 13 to 72 MPa |
| No. 34 | 12 to 71 MPa |
| No. 35 | 15 to 74 MPa |
| No. 36 | 19 to 78 MPa |
| No. 37 | 15 to 73 MPa |
| No. 38 | 11 to 71 MPa |
| No. 39 | 12 to 71 MPa |
| No. 40 | 15 to 73 MPa |
| No. 41 | 13 to 72 MPa |
| No. 42 | 17 to 75 MPa |
| No. 43 | 16 to 73 MPa |
| No. 44 | 19 to 78 MPa |
| No. 45 | 18 to 72 MPa |
| No. 46 | 16 to 74 MPa |
| No. 47 | 14 to 73 MPa |
| No. 48 | 19 to 81 MPa |
| No. 49 | 16 to 75 MPa |
| No. 50 | 13 to 72 MPa |
| No. 51 | 11 to 70 MPa |
| No. 52 | 16 to 75 MPa |
| No. 53 | 13 to 72 MPa |
| No. 54 | 14 to 77 MPa |
| No. 55 | 13 to 73 MPa |
| No. 56 | 15 to 72 MPa |
| No. 57 | 18 to 74 MPa |
| No. 58 | 19 to 77 MPa |
| No. 59 | 26 to 74 MPa |
| No. 60 | 12 to 70 MPa |
| No. 61 | 13 to 72 MPa |
| No. 62 | 15 to 74 MPa |
| No. 63 | 10 to 70 MPa |
| No. 64 | 12 to 71 MPa |
| No. 65 | 13 to 72 MPa |
| No. 66 | 19 to 78 MPa |
| No. 67 | 20 to 81 MPa |
| No. 68 | 16 to 75 MPa |
| No. 69 | 12 to 71 MPa |
| No. 70 | 11 to 70 MPa |
| No. 71 | 10 to 72 MPa |
| No. 72 | 16 to 77 MPa |

### Example 6

### Measurement of Density of Specimen

Specimens were prepared, and surfaces thereof were cleaned using alcohol and distilled water. Weight (W₁) in air of the specimen and weight (W₂) of water vapor were measured with an analytical balance (BP221S, available from Sartorius, Germany) mounted with a densito-kit. Density of the specimen was calculated according to the following equation. This process was equally applied to the alloys of Embodiments 1 to 6.

dₛ=[W₁×(dₗ−dₐ)/(W₁−W₂)]+dₐ

where dₗ indicates the density of liquid (≈1.0000 g/cm³), and

dₐ indicates the density of air (≈0.0012 g/cm³)

Results of measuring the densities of the alloys of Embodiments 1 to 6 are shown in Tables 22 to 24.

TABLE 22
Results of measuring densities of alloys of Embodiments 1 and 2

| | |
|---|---|
| Alloy of Embodiment 1 | Alloy of Embodiment 2 |

| | | | |
|---|---|---|---|
| No. 1 | 7.4 to 15.2 g/cm³ | No. 1 | 7.4 to 15.3 g/cm³ |
| No. 2 | 7.1 to 15.1 g/cm³ | No. 2 | 7.9 to 15.8 g/cm³ |
| No. 3 | 7 to 15 g/cm³ | No. 3 | 7.7 to 15.5 g/cm³ |
| No. 4 | 6.9 to 15.1 g/cm³ | No. 4 | 7.2 to 15.3 g/cm³ |
| No. 5 | 7.9 to 15.8 g/cm³ | No. 5 | 7.1 to 15.1 g/cm³ |
| No. 6 | 7.4 to 15.2 g/cm³ | No. 6 | 7.7 to 15.6 g/cm³ |
| No. 7 | 7.7 to 15.6 g/cm³ | No. 7 | 7.5 to 15.4 g/cm³ |
| No. 8 | 8 to 16 g/cm³ | No. 8 | 7.2 to 15.2 g/cm³ |
| No. 9 | 7.9 to 15.9 g/cm³ | No. 9 | 7.3 to 15.4 g/cm³ |
| No. 10 | 7.5 to 15.4 g/cm³ | No. 10 | 7.7 to 15.4 g/cm³ |
| No. 11 | 7.3 to 15.2 g/cm³ | No. 11 | 7.6 to 15.3 g/cm³ |
| No. 12 | 7.8 to 15.7 g/cm³ | No. 12 | 7.9 to 15.9 g/cm³ |
| No. 13 | 7.6 to 15.4 g/cm³ | No. 13 | 8 to 16.1 g/cm³ |
| No. 14 | 7.1 to 15.1 g/cm³ | No. 14 | 7.4 to 15.2 g/cm³ |
| No. 15 | 7.3 to 15.2 g/cm³ | No. 15 | 7.6 to 15.3 g/cm³ |
| No. 16 | 7.4 to 15.3 g/cm³ | No. 16 | 7.3 to 15.4 g/cm³ |
| No. 17 | 7 to 15.1 g/cm³ | No. 17 | 7.1 to 15.1 g/cm³ |
| No. 18 | 6.9 to 15 g/cm³ | No. 18 | 7.6 to 15.4 g/cm³ |

TABLE 23
Results of measuring densities of alloys of Embodiments 3 to 5

| Alloy of Embodiment 3 | | Alloy of Embodiment 4 | | Alloy of Embodiment 5 | |
|---|---|---|---|---|---|
| No. 1 | 7.9 to 15.5 g/cm³ | No. 1 | 7.2 to 15.2 g/cm³ | No. 1 | 7.6 to 15.2 g/cm³ |
| No. 2 | 7.4 to 15.1 g/cm³ | No. 2 | 7.3 to 15.1 g/cm³ | No. 2 | 7.7 to 15.5 g/cm³ |
| No. 3 | 7.1 to 15 g/cm³ | No. 3 | 7.6 to 15.4 g/cm³ | No. 3 | 7.4 to 15.3 g/cm³ |
| No. 4 | 7.2 to 15.2 g/cm³ | No. 4 | 7.5 to 15 g/cm³ | No. 4 | 7.9 to 15.9 g/cm³ |
| No. 5 | 7.3 to 15.2 g/cm³ | No. 5 | 7.8 to 15.6 g/cm³ | No. 5 | 7.8 to 15.7 g/cm³ |
| No. 6 | 7.5 to 15.4 g/cm³ | No. 6 | 7.6 to 15.7 g/cm³ | No. 6 | 7.3 to 15.5 g/cm³ |
| No. 7 | 7.2 to 15.2 g/cm³ | No. 7 | 7.2 to 15.3 g/cm³ | No. 7 | 7.5 to 15.4 g/cm³ |
| No. 8 | 6.9 to 15.1 g/cm³ | No. 8 | 8 to 16.1 g/cm³ | No. 8 | 7.4 to 15.6 g/cm³ |
| No. 9 | 7.5 to 15.4 g/cm³ | No. 9 | 7.5 to 15.4 g/cm³ | No. 9 | 7.6 to 15.5 g/cm³ |
| No. 10 | 7.3 to 15.2 g/cm³ | No. 10 | 7.2 to 15.3 g/cm³ | No. 10 | 7.7 to 15.4 g/cm³ |
| No. 11 | 7.6 to 15.1 g/cm³ | No. 11 | 7.1 to 15.8 g/cm³ | No. 11 | 7.1 to 15.3 g/cm³ |
| No. 12 | 7.7 to 15.9 g/cm³ | No. 12 | 7 to 15 g/cm³ | No. 12 | 7.3 to 15.2 g/cm³ |
| No. 13 | 7.1 to 15 g/cm³ | No. 13 | 7.5 to 15.4 g/cm³ | No. 13 | 7 to 15.1 g/cm³ |
| No. 14 | 7.6 to 15.4 g/cm³ | No. 14 | 7.6 to 15.3 g/cm³ | No. 14 | 7.1 to 15.3 g/cm³ |
| No. 15 | 7.7 to 15.5 g/cm³ | No. 15 | 7.7 to 15.2 g/cm³ | No. 15 | 7.5 to 15.4 g/cm³ |
| No. 16 | 7.3 to 15.4 g/cm³ | No. 16 | 7.9 to 15.9 g/cm³ | No. 16 | 7.6 to 15.9 g/cm³ |
| No. 17 | 7.9 to 15.7 g/cm³ | No. 17 | 7.1 to 15.2 g/cm³ | No. 17 | 7.9 to 16 g/cm³ |
| No. 18 | 7.7 to 15.9 g/cm³ | No. 18 | 7 to 15.1 g/cm³ | No. 18 | 7.3 to 15.2 g/cm³ |

TABLE 24
Results of measuring density of alloy of Embodiment 6

| | |
|---|---|
| No. 1 | 7.6 to 15.2 g/cm³ |
| No. 2 | 7.7 to 15.5 g/cm³ |
| No. 3 | 7.4 to 15.3 g/cm³ |
| No. 4 | 7.9 to 15.9 g/cm³ |
| No. 5 | 7.8 to 15.7 g/cm³ |
| No. 6 | 7.3 to 15.5 g/cm³ |
| No. 7 | 7.5 to 15.4 g/cm³ |
| No. 8 | 7.4 to 15.6 g/cm³ |
| No. 9 | 7.6 to 15.5 g/cm³ |
| No. 10 | 7.7 to 15.4 g/cm³ |
| No. 11 | 7.1 to 15.3 g/cm³ |
| No. 12 | 7.3 to 15.2 g/cm³ |
| No. 13 | 7 to 15.1 g/cm³ |
| No. 14 | 7.1 to 15.3 g/cm³ |
| No. 15 | 7.5 to 15.4 g/cm³ |
| No. 16 | 7.6 to 15.9 g/cm³ |
| No. 17 | 7.9 to 16 g/cm³ |
| No. 18 | 7.3 to 15.2 g/cm³ |
| No. 19 | 7.5 to 15.4 g/cm³ |
| No. 20 | 8 to 15.9 g/cm³ |
| No. 21 | 7.2 to 15.2 g/cm³ |
| No. 22 | 7.3 to 15.1 g/cm³ |
| No. 23 | 7.6 to 15.4 g/cm³ |
| No. 24 | 7.5 to 15 g/cm³ |
| No. 25 | 7.8 to 15.6 g/cm³ |
| No. 26 | 7.6 to 15.7 g/cm³ |
| No. 27 | 7.2 to 15.3 g/cm³ |
| No. 28 | 8 to 16.1 g/cm³ |
| No. 29 | 7.5 to 15.4 g/cm³ |
| No. 30 | 7.2 to 15.3 g/cm³ |
| No. 31 | 7.1 to 15.8 g/cm³ |
| No. 32 | 7 to 15 g/cm³ |
| No. 33 | 7.5 to 15.4 g/cm³ |
| No. 34 | 7.6 to 15.3 g/cm³ |
| No. 35 | 7.7 to 15.2 g/cm³ |
| No. 36 | 7.9 to 15.9 g/cm³ |
| No. 37 | 7.1 to 15.2 g/cm³ |
| No. 38 | 7.4 to 15.3 g/cm³ |
| No. 39 | 7.9 to 15.5 g/cm³ |
| No. 40 | 7.4 to 15.1 g/cm³ |
| No. 41 | 7.1 to 15 g/cm³ |
| No. 42 | 7.2 to 15.2 g/cm³ |
| No. 43 | 7.3 to 15.2 g/cm³ |
| No. 44 | 7.5 to 15.4 g/cm³ |
| No. 45 | 7.2 to 15.2 g/cm³ |
| No. 46 | 6.9 to 15.1 g/cm³ |
| No. 47 | 7.5 to 15.4 g/cm³ |
| No. 48 | 7.3 to 15.2 g/cm³ |
| No. 49 | 7.6 to 15.1 g/cm³ |
| No. 50 | 7.7 to 15.9 g/cm³ |
| No. 51 | 7.1 to 15 g/cm³ |
| No. 52 | 7.6 to 15.4 g/cm³ |
| No. 53 | 7.7 to 15.5 g/cm³ |
| No. 54 | 7.3 to 15.4 g/cm³ |
| No. 55 | 7.9 to 15.7 g/cm³ |
| No. 56 | 7.7 to 15.9 g/cm³ |
| No. 57 | 7.9 to 15.8 g/cm³ |
| No. 58 | 7.7 to 15.5 g/cm³ |
| No. 59 | 7.2 to 15.3 g/cm³ |
| No. 60 | 7.1 to 15.1 g/cm³ |
| No. 61 | 7.7 to 15.6 g/cm³ |
| No. 62 | 7.5 to 15.4 g/cm³ |
| No. 63 | 7.2 to 15.2 g/cm³ |
| No. 64 | 7.3 to 15.4 g/cm³ |
| No. 65 | 7.7 to 15.4 g/cm³ |
| No. 66 | 7.6 to 15.3 g/cm³ |
| No. 67 | 7.9 to 15.9 g/cm³ |
| No. 68 | 8 to 16.1 g/cm³ |
| No. 69 | 7.4 to 15.2 g/cm³ |
| No. 70 | 7.6 to 15.3 g/cm³ |
| No. 71 | 7.3 to 15.4 g/cm³ |
| No. 72 | 7.1 to 15.1 g/cm³ |

### Example 7

### Measurement of Vickers Hardness of Specimen

Specimens having dimensions of 10 mm×10 mm×1 mm were used, and hardness thereof was measured by applying a load of 0.5 kgf for 10 seconds using a micro-hardness tester (DMH-2, available from Matsuzawa Seili Co., Ltd., Japan). Five points per specimen were measured, and an average thereof was obtained. This process was equally applied to the alloys of Embodiments 1 to 6. Results of measuring the Vickers hardness of the alloys of Embodiments 1 to 6 are shown in Tables 25 to 27.

TABLE 25
Results of measuring Vickers hardness of alloys of
Embodiments 1 and 2

| | |
|---|---|
| Alloy of Embodiment 1 | Alloy of Embodiment 2 |

| | | | |
|---|---|---|---|
| No. 1 | 142 to 203 VHN | No. 1 | 147 to 204 VHN |
| No. 2 | 144 to 204 VHN | No. 2 | 143 to 202 VHN |
| No. 3 | 147 to 206 VHN | No. 3 | 143 to 204 VHN |
| No. 4 | 145 to 204 VHN | No. 4 | 145 to 202 VHN |
| No. 5 | 149 to 209 VHN | No. 5 | 150 to 210 VHN |
| No. 6 | 150 to 210 VHN | No. 6 | 146 to 203 VHN |
| No. 7 | 148 to 207 VHN | No. 7 | 143 to 202 VHN |
| No. 8 | 141 to 202 VHN | No. 8 | 144 to 203 VHN |
| No. 9 | 139 to 200 VHN | No. 9 | 142 to 201 VHN |
| No. 10 | 140 to 201 VHN | No. 10 | 147 to 204 VHN |
| No. 11 | 145 to 202 VHN | No. 11 | 145 to 203 VHN |
| No. 12 | 147 to 205 VHN | No. 12 | 149 to 208 VHN |
| No. 13 | 145 to 202 VHN | No. 13 | 143 to 202 VHN |
| No. 14 | 146 to 203 VHN | No. 14 | 144 to 203 VHN |
| No. 15 | 147 to 205 VHN | No. 15 | 149 to 208 VHN |
| No. 16 | 143 to 202 VHN | No. 16 | 143 to 202 VHN |
| No. 17 | 149 to 208 VHN | No. 17 | 139 to 201 VHN |
| No. 18 | 143 to 202 VHN | No. 18 | 146 to 205 VHN |

TABLE 26
Results of measuring Vickers hardness of alloys of
Embodiments 3 to 5

| | | |
|---|---|---|
| Alloy of | Alloy of | Alloy of |
| Embodiment 3 | Embodiment 4 | Embodiment 5 |

| | | | | | |
|---|---|---|---|---|---|
| No. 1 | 142 to 203 | No. 1 | 141 to 201 | No. 1 | 143 to 202 |
| | VHN | | VHN | | VHN |
| No. 2 | 145 to 204 | No. 2 | 146 to 203 | No. 2 | 145 to 202 |
| | VHN | | VHN | | VHN |
| No. 3 | 141 to 201 | No. 3 | 143 to 202 | No. 3 | 141 to 201 |
| | VHN | | VHN | | VHN |
| No. 4 | 142 to 203 | No. 4 | 144 to 205 | No. 4 | 149 to 207 |
| | VHN | | VHN | | VHN |
| No. 5 | 145 to 204 | No. 5 | 149 to 208 | No. 5 | 150 to 207 |
| | VHN | | VHN | | VHN |
| No. 6 | 148 to 206 | No. 6 | 150 to 210 | No. 6 | 141 to 201 |
| | VHN | | VHN | | VHN |
| No. 7 | 147 to 204 | No. 7 | 146 to 202 | No. 7 | 145 to 202 |
| | VHN | | VHN | | VHN |
| No. 8 | 145 to 203 | No. 8 | 143 to 205 | No. 8 | 143 to 202 |
| | VHN | | VHN | | VHN |
| No. 9 | 150 to 209 | No. 9 | 145 to 203 | No. 9 | 142 to 201 |
| | VHN | | VHN | | VHN |
| No. | 141 to 201 | No. | 147 to 202 | No. | 140 to 201 |
| 10 | VHN | 10 | VHN | 10 | VHN |
| No. | 143 to 202 | No. | 149 to 210 | No. | 146 to 203 |
| 11 | VHN | 11 | VHN | 11 | VHN |
| No. | 146 to 205 | No. | 150 to 209 | No. | 145 to 204 |
| 12 | VHN | 12 | VHN | 12 | VHN |
| No. | 149 to 208 | No. | 145 to 203 | No. | 149 to 205 |
| 13 | VHN | 13 | VHN | 13 | VHN |
| No. | 145 to 204 | No. | 143 to 202 | No. | 141 to 202 |
| 14 | VHN | 14 | VHN | 14 | VHN |
| No. | 143 to 202 | No. | 142 to 205 | No. | 146 to 205 |
| 15 | VHN | 15 | VHN | 15 | VHN |
| No. | 146 to 205 | No. | 145 to 203 | No. | 139 to 200 |
| 16 | VHN | 16 | VHN | 16 | VHN |
| No. | 146 to 203 | No. | 149 to 207 | No. | 141 to 202 |
| 17 | VHN | 17 | VHN | 17 | VHN |
| No. | 148 to 204 | No. | 147 to 203 | No. | 146 to 204 |
| 18 | VHN | 18 | VHN | 18 | VHN |

TABLE 27
Results of measuring Vickers hardness of alloy of Embodiment 6

| | |
|---|---|
| No. 1 | 142 to 201 VHN |
| No. 2 | 145 to 204 VHN |
| No. 3 | 143 to 202 VHN |
| No. 4 | 150 to 210 VHN |
| No. 5 | 144 to 203 VHN |
| No. 6 | 143 to 202 VHN |
| No. 7 | 141 to 201 VHN |
| No. 8 | 146 to 203 VHN |
| No. 9 | 143 to 202 VHN |
| No. 10 | 144 to 205 VHN |
| No. 11 | 149 to 208 VHN |
| No. 12 | 150 to 210 VHN |
| No. 13 | 146 to 202 VHN |
| No. 14 | 143 to 205 VHN |
| No. 15 | 145 to 203 VHN |
| No. 16 | 147 to 202 VHN |
| No. 17 | 149 to 210 VHN |
| No. 18 | 150 to 209 VHN |
| No. 19 | 145 to 203 VHN |
| No. 20 | 143 to 202 VHN |
| No. 21 | 142 to 205 VHN |
| No. 22 | 145 to 203 VHN |
| No. 23 | 149 to 207 VHN |
| No. 24 | 147 to 203 VHN |
| No. 25 | 148 to 207 VHN |
| No. 26 | 141 to 202 VHN |
| No. 27 | 139 to 200 VHN |
| No. 28 | 140 to 201 VHN |
| No. 29 | 145 to 202 VHN |
| No. 30 | 147 to 205 VHN |
| No. 31 | 145 to 202 VHN |
| No. 32 | 146 to 203 VHN |
| No. 33 | 147 to 205 VHN |
| No. 34 | 143 to 202 VHN |
| No. 35 | 149 to 208 VHN |
| No. 36 | 143 to 202 VHN |
| No. 37 | 147 to 205 VHN |
| No. 38 | 145 to 203 VHN |
| No. 39 | 142 to 201 VHN |
| No. 40 | 149 to 208 VHN |
| No. 41 | 143 to 202 VHN |
| No. 42 | 145 to 204 VHN |
| No. 43 | 143 to 202 VHN |
| No. 44 | 145 to 202 VHN |
| No. 45 | 141 to 201 VHN |
| No. 46 | 149 to 207 VHN |
| No. 47 | 150 to 207 VHN |
| No. 48 | 141 to 201 VHN |
| No. 49 | 145 to 202 VHN |
| No. 50 | 143 to 202 VHN |
| No. 51 | 142 to 201 VHN |
| No. 52 | 140 to 201 VHN |
| No. 53 | 146 to 203 VHN |
| No. 54 | 145 to 204 VHN |
| No. 55 | 149 to 205 VHN |
| No. 56 | 141 to 202 VHN |
| No. 57 | 146 to 205 VHN |
| No. 58 | 139 to 200 VHN |
| No. 59 | 141 to 202 VHN |
| No. 60 | 146 to 204 VHN |
| No. 61 | 148 to 206 VHN |
| No. 62 | 147 to 204 VHN |
| No. 63 | 145 to 203 VHN |
| No. 64 | 150 to 209 VHN |
| No. 65 | 141 to 201 VHN |
| No. 66 | 143 to 202 VHN |
| No. 67 | 146 to 205 VHN |
| No. 68 | 149 to 208 VHN |
| No. 69 | 145 to 204 VHN |
| No. 70 | 143 to 202 VHN |
| No. 71 | 146 to 205 VHN |
| No. 72 | 146 to 203 VHN |

### Example 8

### Measurement of Melting Range of Specimen

A small amount (46.5 mg) of sample was taken, and a melting range was measured from 800 to 1100° C. at a rate of 10° C./min using a differential scanning calorimeter (STA 409 PC TG/DSC, available from Netzch Co, Ltd., Germany). This process was equally applied to the alloys of Embodiments 1 to 6. Results of measuring the melting ranges of the alloys of Embodiments 1 to 6 are shown in Tables 28 to 30.

TABLE 28
Results of measuring melting ranges of alloys of
Embodiments 1 and 2

| | |
|---|---|
| Alloy of Embodiment 1 | Alloy of Embodiment 2 |

| | | | |
|---|---|---|---|
| No. 1 | 890 to 1200° C. | No. 1 | 894 to 1200° C. |
| No. 2 | 893 to 1202° C. | No. 2 | 896 to 1203° C. |
| No. 3 | 880 to 1200° C. | No. 3 | 890 to 1201° C. |
| No. 4 | 888 to 1210° C. | No. 4 | 900 to 1210° C. |
| No. 5 | 890 to 1211° C. | No. 5 | 889 to 1204° C. |
| No. 6 | 897 to 1215° C. | No. 6 | 897 to 1209° C. |
| No. 7 | 894 to 1203° C. | No. 7 | 894 to 1204° C. |
| No. 8 | 889 to 1201° C. | No. 8 | 896 to 1203° C. |
| No. 9 | 893 to 1205° C. | No. 9 | 898 to 1206° C. |
| No. 10 | 897 to 1203° C. | No. 10 | 894 to 1203° C. |
| No. 11 | 894 to 1206° C. | No. 11 | 891 to 1203° C. |
| No. 12 | 899 to 1210° C. | No. 12 | 896 to 1203° C. |
| No. 13 | 893 to 1202° C. | No. 13 | 895 to 1204° C. |
| No. 14 | 890 to 1210° C. | No. 14 | 897 to 1204° C. |
| No. 15 | 893 to 1205° C. | No. 15 | 891 to 1202° C. |
| No. 16 | 897 to 1206° C. | No. 16 | 887 to 1203° C. |
| No. 17 | 885 to 1202° C. | No. 17 | 900 to 1215° C. |
| No. 18 | 891 to 1200° C. | No. 18 | 890 to 1203° C. |

TABLE 29
Results of measuring melting ranges of alloys of
Embodiments 3 to 5

| Alloy of | | Alloy of | | Alloy of | |
|---|---|---|---|---|---|
| Embodiment 3 | | Embodiment 4 | | Embodiment 5 | |
| No. 1 | 897 to | No. 1 | 894 to | No. 1 | 894 to |
| | 1205° C. | | 1205° C. | | 1203° C. |
| No. 2 | 900 to | No. 2 | 896 to | No. 2 | 892 to |
| | 1210° C. | | 1201° C. | | 1201° C. |
| No. 3 | 890 to | No. 3 | 897 to | No. 3 | 900 to |
| | 1200° C. | | 1204° C. | | 1200° C. |
| No. 4 | 885 to | No. 4 | 890 to | No. 4 | 890 to |
| | 1205° C. | | 1210° C. | | 1202° C. |
| No. 5 | 897 to | No. 5 | 899 to | No. 5 | 894 to |
| | 1205° C. | | 1209° C. | | 1205° C. |
| No. 6 | 894 to | No. 6 | 892 to | No. 6 | 893 to |
| | 1203° C. | | 1201° C. | | 1202° C. |
| No. 7 | 891 to | No. 7 | 900 to | No. 7 | 898 to |
| | 1202° C. | | 1210° C. | | 1207° C. |
| No. 8 | 897 to | No. 8 | 897 to | No. 8 | 897 to |
| | 1206° C. | | 1205° C. | | 1203° C. |
| No. 9 | 890 to | No. 9 | 900 to | No. 9 | 895 to |
| | 1205° C. | | 1200° C. | | 1206° C. |
| No. 10 | 900 to | No. 10 | 891 to | No. 10 | 889 to |
| | 1210° C. | | 1201° C. | | 1203° C. |
| No. 11 | 899 to | No. 11 | 885 to | No. 11 | 896 to |
| | 1208° C. | | 1200° C. | | 1204° C. |
| No. 12 | 894 to | No. 12 | 889 to | No. 12 | 897 to |
| | 1205° C. | | 1204° C. | | 1203° C. |
| No. 13 | 895 to | No. 13 | 896 to | No. 13 | 900 to |
| | 1202° C. | | 1207° C. | | 1200° C. |
| No. 14 | 893 to | No. 14 | 897 to | No. 14 | 888 to |
| | 1204° C. | | 1204° C. | | 1208° C. |
| No. 15 | 897 to | No. 15 | 894 to | No. 15 | 894 to |
| | 1205° C. | | 1202° C. | | 1203° C. |
| No. 16 | 889 to | No. 16 | 891 to | No. 16 | 889 to |
| | 1204° C. | | 1203° C. | | 1207° C. |
| No. 17 | 892 to | No. 17 | 896 to | No. 17 | 890 to |
| | 1206° C. | | 1205° C. | | 1209° C. |
| No. 18 | 896 to | No. 18 | 899 to | No. 18 | 887 to |
| | 1209° C. | | 1209° C. | | 1200° C. |

TABLE 30
Results of measuring melting range of alloy of Embodiment 6

| | |
|---|---|
| No. 1 | 894 to 1203° C. |
| No. 2 | 892 to 1201° C. |
| No. 3 | 900 to 1200° C. |
| No. 4 | 890 to 1202° C. |
| No. 5 | 894 to 1205° C. |
| No. 6 | 893 to 1202° C. |
| No. 7 | 898 to 1207° C. |
| No. 8 | 897 to 1203° C. |
| No. 9 | 895 to 1206° C. |
| No. 10 | 889 to 1203° C. |
| No. 11 | 896 to 1204° C. |
| No. 12 | 897 to 1203° C. |
| No. 13 | 900 to 1200° C. |
| No. 14 | 888 to 1208° C. |
| No. 15 | 894 to 1203° C. |
| No. 16 | 889 to 1207° C. |
| No. 17 | 890 to 1209° C. |
| No. 18 | 887 to 1200° C. |
| No. 19 | 889 to 1204° C. |
| No. 20 | 897 to 1209° C. |
| No. 21 | 894 to 1204° C. |
| No. 22 | 896 to 1203° C. |
| No. 23 | 898 to 1206° C. |
| No. 24 | 894 to 1203° C. |
| No. 25 | 891 to 1203° C. |
| No. 26 | 896 to 1203° C. |
| No. 27 | 895 to 1204° C. |
| No. 28 | 897 to 1204° C. |
| No. 29 | 891 to 1202° C. |
| No. 30 | 887 to 1203° C. |
| No. 31 | 900 to 1215° C. |
| No. 32 | 890 to 1203° C. |
| No. 33 | 894 to 1206° C. |
| No. 34 | 895 to 1209° C. |
| No. 35 | 900 to 1200° C. |
| No. 36 | 897 to 1204° C. |
| No. 37 | 894 to 1205° C. |
| No. 38 | 896 to 1201° C. |
| No. 39 | 897 to 1204° C. |
| No. 40 | 890 to 1210° C. |
| No. 41 | 899 to 1209° C. |
| No. 42 | 892 to 1201° C. |
| No. 43 | 900 to 1210° C. |
| No. 44 | 897 to 1205° C. |
| No. 45 | 900 to 1200° C. |
| No. 46 | 891 to 1201° C. |
| No. 47 | 885 to 1200° C. |
| No. 48 | 889 to 1204° C. |
| No. 49 | 896 to 1207° C. |
| No. 50 | 897 to 1204° C. |
| No. 51 | 894 to 1202° C. |
| No. 52 | 891 to 1203° C. |
| No. 53 | 896 to 1205° C. |
| No. 54 | 899 to 1209° C. |
| No. 55 | 890 to 1200° C. |
| No. 56 | 894 to 1202° C. |
| No. 57 | 897 to 1205° C. |
| No. 58 | 897 to 1205° C. |
| No. 59 | 900 to 1210° C. |
| No. 60 | 890 to 1200° C. |
| No. 61 | 885 to 1205° C. |
| No. 62 | 897 to 1205° C. |
| No. 63 | 894 to 1203° C. |
| No. 64 | 891 to 1202° C. |
| No. 65 | 897 to 1206° C. |
| No. 66 | 890 to 1205° C. |
| No. 67 | 900 to 1210° C. |
| No. 68 | 899 to 1208° C. |
| No. 69 | 894 to 1205° C. |
| No. 70 | 895 to 1202° C. |
| No. 71 | 893 to 1204° C. |
| No. 72 | 897 to 1205° C. |

### Example 9

### Measurement of Discoloration Resistance of Specimen

Specimens having a diameter of (10±1) mm and a thickness of (0.5±0.1) mm were prepared, immersed in 0.1M sodium sulfide aqueous solution (CAS No. 1313-84-4) for 10 to 15 seconds using a discoloration tester (Tarnish tester, available from Myung Sung Industry, Korea), cleaned after 72 hours, and observed with the naked eye in comparison, with untested specimens (control group). This process was equally applied to the alloys of Embodiments 1 to 6. As a result of comparing with the untested specimens (control group), all the alloys of Embodiments 1 to 6 were not discolored.

### Example 10

### Cytotoxicity Test of Specimen

Four specimens having dimensions of 10 mm×10 mm×1 mm were prepared as a test group, and slide glasses having dimensions of 10 mm×10 mm×1 mm (negative control group) and natural rubber latexes having dimensions of 10 mm×10 mm×1 mm (positive control group) were prepared as control groups. L-929 cell (passage number 7) suspension (2×10⁵ cells/ml) was divided into petri-dishes, and cultured in a 5% CO₂ incubator for 24 hours. A monolayer culture state of the cultured solutions (80% or more of a culture container area) and a form of cells were checked with a microscope. The cultured solutions were removed, and a RPMI Agar medium in which a serum was included was added in unit of 10 ml. When the Agar was cured, a staining solution (ratio of Neutral red to DPBS is 0.3 ml to 10 ml) was filtered and injected in unit of about 10 ml. Afterwards, the specimens were sealed with a silver foil, and were stored in the CO₂ incubator for 15 to 20 minutes. Then, it was checked with the microscope whether or not the specimens were stained, and the staining solution was removed. The specimens of the test group and the control groups were placed and cultured in the CO₂ incubator for 24 hours. Cytotoxicity was evaluated according to Table 31. This process was equally applied to the alloys of Embodiments 1 to 6. The results are given as in Table 32. As shown in Table 32, it can be found that, in a state in which the positive and negative control groups are normal, the alloys of Embodiments 1 to 6 have no toxicity.

TABLE 31
Cytotoxicity based on reaction grade

| Grade | Reactivity | Description of reaction zone |
|---|---|---|
| 0 | None | No decolored portion under or |
| | | adjacent to specimen |
| 1 | Slight | Slight cell deformation only |
| | | under specimen |
| 2 | Mild | Limited reaction zone only under |
| | | specimen |
| 3 | Moderate | Reaction zone within 1.0 cm from |
| | | specimen |
| 4 | Severe | Reaction zone beyond 1.0 cm from |
| | | specimen |

TABLE 32
Results of testing cytotoxicity of alloys of Embodiments 1 to 6

| | | | Specimens |
|---|---|---|---|
| Test type | Positive | Negative | (Embodiments 1 to 6) |
| Cytotoxicity | 3 | 0 | 0 |

### Example 11

### Acute Systemic Toxicity Test of Specimen

An eluate in which a saline solution of 20 ml was used per specimen 4 g and homosexual albino mice that had weight of 17 to 23 g, were healthy, and were not previously used as test animals were used. The test animals were divided into a test group for five and a control group for five, and experienced an adaptive period. The eluate was injected into the test group through a tail vein using a 24 gauge needle syringe, and the saline solution of 50 ml/kg was injected into the control group. The weights and biological abnormal symptoms of the test animals were observed with the naked eye just after the injection, after 4 hours, after 24 hours, after 48 hours, and after 72 hours. This process was equally applied to the alloys of Embodiments 1 to 6. The results are given as in Table 33. As shown in Table 33, no individuals show biological abnormal symptoms and are dead in both the test and control groups during an observation period.

TABLE 33
Results of testing acute systemic toxicity of alloys of
Embodiments 1 to 6

| | | | | Abnormal symptom/weight change | | | |
|---|---|---|---|---|---|---|---|
| | | | | Just | | | |
| | | Life and death | | after | 24 | 48 | 72 |
| | | Alive | Dead | injection | hours | hours | hours |
| Test | 1 | ∘ | | None | None | None | None |
| group | 2 | ∘ | | None | None | None | None |
| | 3 | ∘ | | None | None | None | None |
| | 4 | ∘ | | None | None | None | None |
| | 5 | ∘ | | None | None | None | None |
| Control | 1 | ∘ | | None | None | None | None |
| group | 2 | ∘ | | None | None | None | None |
| | 3 | ∘ | | None | None | None | None |
| | 4 | ∘ | | None | None | None | None |
| | 5 | ∘ | | None | None | None | None |

### Example 12

### Test of Stimulating Mucous Membrane of Oral Cavity of Specimen

Three specimens were prepared along with a ball pocket (cotton ball) that had a diameter of 5 mm and was immersed in an eluate, and three homosexual Syrian hamsters were prepared as test animals. A proper necklace having a width of 3 to 4 mm is worn around the neck of each animal, and weight of each animal was measured for 7 days every day during a test period. The necklace was removed from each animal, and the ball pocket was turned inside out and cleaned. Then, it was checked whether or not abnormality was present. Afterwards, the hamsters in which an adequate amount of specimen was inserted into the ball pocket were used as a test group, and the hamsters in which no specimen was inserted were used as a control group. The ball pocket was adapted to be exposed to a mucous membrane of oral cavity for 5 minutes or more, and then was cleaned with a saline solution. The mucous membrane of oral cavity was observed with the naked eye. A sample of tissue was separated from the ball pocket at the sacrifice of the hamster, and the tissue was observed. Results of the observation were recorded according to Tables 14 to 16. This process was equally applied to the alloys of Embodiments 1 to 6. The results are given as in Tables 37 and 38. As shown in Tables 37 and 38, no erythema or edema was observed from the test and control groups.

TABLE 34
Grade system of oral cavity reaction

| | |
|---|---|
| Reaction | Grade |

Formation of erythema and eschar

| | |
|---|---|
| No erythema | 0 |
| Very slight (almost imperceptible) erythema | 1 |
| Well formed erythema | 2 |
| Moderate erythema | 3 |
| Severe erythema (rubor) for which no grade of | 4 |
| erythema is given due to formation of eschar | |

TABLE 35
Microscopic examination grade system of oral cavity
tissue reaction

| | |
|---|---|
| Reaction | Grade |

1. Epithelium

| | |
|---|---|
| Normal, unimpaired | 0 |
| Deformation or inactivation of cell | 1 |
| Metaplasia | 2 |
| Local erosion | 3 |
| Systemic erosion | 4 |

2. Per high power field

| | |
|---|---|
| None | 0 |
| Slight (25 or less) | 1 |
| Mild (26 to 50) | 2 |
| Moderate (51 to 100) | 3 |
| Remarkable (100 or more) | 4 |

3. Blood vessel congestion

| | |
|---|---|
| None | 0 |
| Slight | 1 |
| Mild | 2 |
| Moderate | 3 |
| Remarkable, accompanied with | 4 |
| blood vessel rupture | |

4. Edema

| | |
|---|---|
| None | 0 |
| Slight | 1 |
| Mild | 2 |
| Moderate | 3 |
| Remarkable | 4 |

TABLE 36
Stimulus index

| Average grade | Reaction analysis |
|---|---|
| 0 | None |
| 1-4 | Slight |
| 5-8 | Mild |
| 9-11 | Moderate |
| 12-16 | Severe |

TABLE 37
Results of visually observing mucous membrane of oral
cavity in test of stimulating mucous membrane of oral cavity

| | | Visual | | |
|---|---|---|---|---|
| Animal No. | Weight (g) | observation | Grade | Average |
| 1 | 90 | Normal | 0 | 0 |
| 2 | 99 | Normal | 0 | |
| 3 | 102 | Normal | 0 | |

TABLE 38
Tissue evaluation grade in test of stimulating mucous
membrane of oral cavity

| | | | Per | | | | |
|---|---|---|---|---|---|---|---|
| | | | high | Blood | | | |
| | | | power | vessel | | | Stimulus |
| | Animal No. | Epithelium | field | congestion | Edema | Average | index |
| Test | 1 | 0 | 0 | 0 | 0 | 0 | None |
| group | 2 | 0 | 0 | 0 | 0 | | |
| | 3 | 0 | 0 | 0 | 0 | | |
| Control | 1 | 0 | 0 | 0 | 0 | 0 | None |
| group | 2 | 0 | 0 | 0 | 0 | | |
| | 3 | 0 | 0 | 0 | 0 | | |

In the dental alloy according to the present invention, a content of gold is reduced compared to that of an existing casting alloy. Thereby, price competitiveness can be increased, and mechanical properties of the existing alloy can be equally maintained.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

### INDUSTRIAL APPLICABILITY

The dental alloy according to the invention can maintain the same mechanical properties of conventional alloys while enhancing price competitiveness by reducing the gold content when compared with conventional casting alloys.

1. A dental alloy adapted for computer-aided design/computer-aided manufacturing (CAD/CAM) machining, the dental alloy comprising palladium (Pd) in an amount of 15% to 70% by weight and indium (In) in an amount of 10% to 60% by weight.

2. The dental alloy according to claim 1, further comprising at least one selected from the group consisting of silver (Ag) in an amount of 10% to 60% by weight, gold (Au) in an amount of 5% to 50% by weight, nickel (Ni) in an amount of 10% to 60% by weight, cobalt (Co) in an amount of 10% to 60% by weight, and a platinum group element in an amount of 10% to 60% by weight.
